(19) United States
(12) Patent Application Publication
(10) Pub. No.: US 2017/0242357 A1
(43) Pub. Date: Aug. 24, 2017

(54) IMAGE FORMING METHOD AND TONER SET

(71) Applicant: Konica Minolta, Inc., Tokyo (JP)

(72) Inventors: Aya Shirai, Tokyo (JP); Junya Onishi, Tokyo (JP); Shiro Hirano, Tokyo (JP); Kouji Sugama, Tokyo (JP); Noboru Ueda, Tokyo (JP)

(21) Appl. No.: 15/271,880

(22) Filed: Sep. 21, 2016

(30) Foreign Application Priority Data
Feb. 19, 2016 (JP) 2016-030115

(51) Int. Cl. G03G 9/087; G03G 9/09

(52) U.S. Cl. CPC G03G 9/08711; G03G 9/0926; G03G 9/0904; G03G 9/091; G03G 9/092; G03G 9/08755

(57) ABSTRACT

An image forming method of the present invention uses a specific toner set. The toner set includes a yellow toner, a magenta toner, a cyan toner and a black toner, and each of these toners contains an amorphous resin, a crystalline resin and a colorant. The colorant of the black toner contains a conductive black colorant. There is a specific relationship between an exothermic peak temperature of the black toner and exothermic peak temperatures of the chromatic color toners.

### CROSS REFERENCE TO RELATED APPLICATIONS

This application is entitled to and claims the benefit of Japanese Patent Application No. 2016-030115, filed on Feb. 19, 2016, the disclosure of which including the specification, drawings and abstract is incorporated herein by reference in its entirety.

### BACKGROUND OF THE INVENTION

1. Field of the Invention

The present invention relates to an image forming method and a toner set.

2. Description of Related Art

Recently, in order to save more energy for purposes of increasing a printing speed and reducing environmental load in an electrophotographic image forming apparatus, an electrostatic latent image developing toner (hereinafter sometimes simply referred to as the “toner”) heat-fixed at a lower temperature is demanded. It is necessary to lower, for example, a melting temperature, a melt viscosity and the like of a binder resin in such a toner, and a toner improved in low-temperature fixability by adding a crystalline resin such as a crystalline polyester resin as a plasticizer (fixing agent) has been proposed.

With respect to such a toner containing crystalline polyester, a method by which the low-temperature fixability and inhibition of abnormal image formation due to agglomeration of the toner can be both attained is known (see, for example, Japanese Patent Application Laid-Open No. 2014-048551). Also with respect to such a toner, a method in which amounts of Si and Ti contained in an external additive are set to satisfy a specific relationship between a black toner and other color toners so as to attain high transferability and a high quality image is stably formed in full color image formation owing to the high transfer efficiency is known (see, for example, Japanese Patent Application Laid-Open No. 2006-276076).

A crystalline resin generally has a characteristic that it has low electrical resistance because of high crystallinity. Therefore, if an image is formed by an electrophotographic method using a toner containing a crystalline resin, charge stability may be lowered in some cases. In particular, in a black toner containing a conductive pigment such as carbon black or iron oxide, the lowering of the charge stability due to the use of the crystalline resin becomes conspicuous, and particularly in a transfer step, an image quality defect such as a fogging or a transfer failure may occur in some cases. Neither of the above-described patent literatures, however, describes retention of the charge stability of the toner, particularly, inhibition of an image quality defect such as a fogging or a transfer failure occurring in a transfer step.

In this manner, there still remains room for examinations to be made for attaining the low-temperature fixability and the transferability in the electrophotographic image forming method using a toner containing a crystalline resin.

### SUMMARY OF THE INVENTION

An object of the present invention is to provide an image forming method in which low-temperature fixability and transferability can be both attained in using a toner containing a crystalline resin.

The present inventors found the following to accomplish the present invention: If the same crystalline resin is used in respective toners included in a toner set, as the exothermic peak temperature of the toner is lower, the crystalline domain of the crystalline resin contained in the toner is smaller and dispersibility of a colorant contained in the toner is higher. As a characteristic of the present invention, in toners each containing crystalline polyester, the exothermic peak temperature of a black toner is in a prescribed range lower than the exothermic peak temperatures of the other chromatic color (yellow, magenta and cyan) toners.

To achieve at least one of the abovementioned objects, an electrophotographic image forming method reflecting one aspect of the present invention includes transferring, from a photoconductor onto a transfer member, at least one toner selected from the group consisting of a yellow toner, a magenta toner, a cyan toner and a black toner, the at least one toner being born on the photoconductor and developing an electrostatic latent image on the photoconductor,

wherein each of the yellow toner, the magenta toner, the cyan toner and the black toner contains an amorphous resin, a crystalline resin and a colorant,

the colorant of the black toner contains a conductive black colorant, and

exothermic peak temperatures of the yellow toner, the magenta toner, the cyan toner and the black toner obtained in temperature decrease in differential scanning calorimetry satisfy the following expressions 1-1 to 1-3:

0.5≦rc(Y)−rc(K)≦10 Expression 1-1:

0.5≦rc(M)−rc(K)≦10 Expression 1-2:

0.5≦rc(C)−rc(K)≦10. Expression 1-3:

In the expressions mentioned above, rc(K) represents the exothermic peak temperature (° C.) of the black toner, rc(Y) represents the exothermic peak temperature (° C.) of the yellow toner, rc(M) represents the exothermic peak temperature (° C.) of the magenta toner, and rc(C) represents the exothermic peak temperature (° C.) of the cyan toner.

To achieve at least one of the aforementioned objects, the present invention provides a toner set including the toners used in the aforementioned image forming method.

### BRIEF DESCRIPTION OF DRAWINGS

The present invention will become more fully understood from the detailed description given hereinbelow and the appended drawings which are given by way of illustration only, and thus are not intended as a definition of the limits of the present invention, and wherein:

FIG. 1 is a schematic diagram illustrating an example of the structure of an image forming apparatus used in an image forming method according to an embodiment of the present invention;

FIG. 2 is a schematic diagram illustrating an example of the structure of a developing device used in the image forming method; and

FIG. 3 is a schematic diagram illustrating an example of a toner bottle containing a toner used in the image forming method.

### DESCRIPTION OF THE PREFERRED EMBODIMENTS

An image forming method according to an embodiment of the present invention is an electrophotographic image forming method, and includes a step of transferring, from a photoconductor onto a transfer member, at least one toner selected from the group consisting of a yellow toner, a magenta toner, a cyan toner and a black toner, which is born on the photoconductor and develops an electrostatic latent image on the photoconductor. The image forming method can be practiced similarly to a known electrophotographic image forming method except that a toner set described below is used as toners of respective colors.

The toner set includes a yellow toner, a magenta toner, a cyan toner and a black toner. The toner set means a combination of toners used or to be used in the aforementioned image forming method. The toner set may be, for example, in a state where all the toners of the respective colors are contained in developer containers of developing devices of the respective colors in a full-color image forming apparatus, or may be a set of toner bottles or a set of process cartridges of all these colors respectively containing the toners of the corresponding colors.

Each of the yellow toner, the magenta toner, the cyan toner and the black toner contains an amorphous resin, a crystalline resin and a colorant. The colorant of the black toner contains a conductive black colorant, and exothermic peak temperatures of the yellow toner, the magenta toner, the cyan toner and the black toner, obtained in temperature decrease in differential scanning calorimetry, satisfy the following expressions 1-1 to 1-3:

0.5≦rc(Y)−rc(K)≦10 Expression 1-1:

0.5≦rc(M)−rc(K)≦10 Expression 1-2:

0.5≦rc(C)−rc(K)≦10 Expression 1-3:

In the above-described expressions, rc(K) represents the exothermic peak temperature (° C.) of the black toner, rc(Y) represents the exothermic peak temperature (° C.) of the yellow toner, rc(M) represents the exothermic peak temperature (° C.) of the magenta toner, and rc(C) represents the exothermic peak temperature (° C.) of the cyan toner.

Specifically, the black toner has a characteristic that its exothermic peak temperature is lower than the exothermic peak temperatures of the toners of the other colors (hereinafter sometimes referred to as the “chromatic color toners”) by a difference falling in a specific range.

If a difference between the exothermic peak temperature rc(K) of the black toner and the exothermic peak temperature rc of a chromatic color toner is smaller than 0.5° C., transferability may become insufficient in some cases, and a good image may not be obtained by superimposing the black toner and the chromatic color toner. If the temperature difference exceeds 10° C., low-temperature fixability may become insufficient in some cases, and glossiness may become uneven due to a transfer failure in an image obtained by superimposing the black toner and the chromatic color toner.

From the viewpoint of improving both the transferability and the low-temperature fixability, the difference between the exothermic peak temperature rc(K) of the black toner and the exothermic peak temperature rc of the chromatic color toner is preferably 1.5 to 8° C., and more preferably 3 to 6° C. As long as the effects of the present embodiment can be obtained, merely some of the chromatic color toners may have the preferable temperature difference, but it is preferable that all the chromatic color toners have the preferable temperature difference.

If the respective toners satisfy the relationships in the exothermic peak temperature, the transferability and the low-temperature fixability are improved probably for the following reason:

During the production of the toner, when toner materials are heated at a temperature equal to or higher than a glass transition temperature of the toner and a melting point of the crystalline resin and then cooled, crystallization occurs in the vicinity of an exothermic peak temperature of the crystalline resin to form a crystalline domain. As the temperature at this point is higher, the crystallization occurs at a higher temperature and a smaller number of crystal nuclei are generated, and hence, a crystalline domain to be obtained becomes larger. Besides, since a surrounding resin is placed in a state having a high mobility, coalescence of crystalline domains is easily caused, and accordingly, dispersibility of the colorant is also lowered.

On the contrary, if the exothermic peak temperature of the crystalline resin is lower, the crystallization occurs at a lower temperature, and hence, a larger number of crystal nuclei are generated, and a crystalline domain to be obtained becomes smaller. Besides, since a surrounding resin is placed in a state having a low mobility, the coalescence of crystalline domains is difficult to occur. Accordingly, the dispersibility of the colorant is not impaired, and both the crystalline domain and the colorant can be kept in a finely dispersed state.

If the exothermic peak temperature of the black toner is set in the above-described range with reference to that of the chromatic color toner, the crystalline domain and the conductive pigment can be well dispersed, and hence the black toner can keep charge stability equivalent to that of the chromatic color toner. This is probably the reason why an excellent image free from a fogging, a transfer failure and glossiness unevenness can be obtained.

The exothermic peak temperature rc of the toner of each color can be obtained as follows: Five (5) mg of a sample is enclosed in an aluminum pan “KITNO. B0143013”, the resultant pan is set in a sample holder of a thermal analyzer “Diamond DSC” (manufactured by PerkinElmer, Inc.), and the temperature is varied in order of heating, cooling and heating. In the first heating and the second heating, the temperature is increased from 0° C. to 100° C. at a temperature rise rate of 10° C./min, and the temperature of 100° C. is kept for 1 minute, and in the cooling, the temperature is decreased from 100° C. to 0° C. at a temperature drop rate of 10° C./min, and the temperature of 0° C. is kept for 1 minute. A temperature of a peak top of an exothermic peak on an endothermic curve obtained in the cooling is defined as an exothermic peak temperature rc. If two or more peaks are observed in the measurement, a temperature corresponding to the largest peak intensity is defined as the exothermic peak temperature rc.

The exothermic peak temperature rc of the toner of each color is preferably 45 to 75° C. from the viewpoint of attaining both high-temperature storage stability and low-temperature fixability. If the exothermic peak temperature is lower than 45° C., the crystalline resin contained in the toner is difficult to crystallize, and hence the high-temperature storage stability and tack property may be degraded in some cases. If it is higher than 75° C., it may be difficult to attain the low-temperature fixability in some cases.

The exothermic peak temperature corresponds to change in the amount of heat caused by heat generation accompanying the crystallization of a crystalline substance including the crystalline resin contained in the toner. The exothermic peak temperature depends upon the crystalline substance, and is affected not only by properties inherent to the crystalline substance but also by the types, the amounts and the like of a binder resin and internal additives such as a colorant contained in the toner. For example, the temperature difference in the exothermic peak temperature can be adjusted by molecular weights of the binder resins of the toners of the respective colors, and the exothermic peak temperature tends to be higher as the molecular weight is larger. Besides, the temperature difference in the exothermic peak temperature can be adjusted also by contents of a wax in the toners of the respective colors, and the exothermic peak temperature tends to be higher as the content of the wax is larger.

Each of the toners of the present embodiment contains the amorphous resin, the crystalline resin and the colorant. The amorphous resin and the crystalline resin constitute what is called a binder resin.

The amorphous resin refers to a resin not having crystallinity described later. The amorphous resin is, for example, a resin having no melting point but having a comparatively high glass transition temperature Tg in differential scanning calorimetry (DSC) of the amorphous resin or the toner particle.

Assuming that the glass transition temperature obtained in the first heating process in the DSC is indicated by Tg1 and the glass transition temperature obtained in the second heating process is indicated by Tg2, the glass transition temperature Tg1 of the amorphous resin is preferably 35 to 80° C., and particularly preferably 45 to 65° C. The glass transition temperature Tg2 of the amorphous resin is preferably 20 to 70° C., and particularly preferably 30 to 55° C.

The glass transition temperature can be measured in accordance with a method (DSC) prescribed in ASTM (American Society for Testing and Materials) Standard D3418-82. In the measurement, Diamond DSC (manufactured by PerkinElmer, Inc.), DSC-7 differential scanning calorimeter (manufactured by PerkinElmer, Inc.) TAC7/DX thermal analyzer controller (manufactured by PerkinElmer, Inc.) or the like can be used.

One or more amorphous resins may be used. Examples of the amorphous resin include a vinyl resin, a urethane resin, a urea resin and amorphous polyester resins such as a styrene-acrylic modified polyester resin. In particular, a vinyl resin unit is preferably used from the viewpoint of controllability of thermoplasticity.

The vinyl resin is, for example, a polymer of a vinyl compound, and examples include an acrylic acid ester resin, a styrene-acrylic acid ester resin and an ethylene-vinyl acetate resin. In particular, the styrene-acrylic acid ester resin (styrene-acrylic resin) is preferably used from the viewpoint of plasticity obtained in heat fixing.

The styrene-acrylic resin is formed by addition polymerization of at least a styrene monomer and a (meth)acrylic acid ester monomer. The styrene monomer includes not only styrene represented by a structural formula of CH₂═CH—C₆H₅ but also styrene derivatives having a known side chain or functional group in the styrene structure.

The (meth)acrylic acid ester monomer includes not only an acrylic acid ester and a methacrylic acid ester represented by CH(R₁)═CHCOOR₂ (wherein R₁ represents a hydrogen atom or a methyl group, and R₂ represents a C₁₋₂₄ alkyl group) but also acrylic acid ester derivatives and methacrylic acid ester derivatives having a known side chain or functional group in the structures of these esters.

Examples of the styrene monomer include styrene, o-methylstyrene, m-methylstyrene, p-methylstyrene, α-methylstyrene, p-phenylstyrene, p-ethylstyrene, 2,4-dimethylstyrene, p-tert-butylstyrene, p-n-hexylstyrene, p-n-octylstyrene, p-n-nonylstyrene, p-n-decylstyrene and p-n-dodecylstyrene.

Examples of the (meth)acrylic acid ester monomer include acrylic acid ester monomers such as methyl acrylate, ethyl acrylate, isopropyl acrylate, n-butyl acrylate, t-butyl acrylate, isobutyl acrylate, n-octyl acrylate, 2-ethylhexyl acrylate, stearyl acrylate, lauryl acrylate and phenyl acrylate; and methacrylic acid esters such as methyl methacrylate, ethyl methacrylate, n-butyl methacrylate, isopropyl methacrylate, isobutyl methacrylate, t-butyl methacrylate, n-octyl methacrylate, 2-ethylhexyl methacrylate, stearyl methacrylate, lauryl methacrylate, phenyl methacrylate, diethylaminoethyl methacrylate and dimethylaminoethyl methacrylate.

Herein, the term “(meth)acrylic acid ester monomer” is used as a generic name of an “acrylic acid ester monomer” and a “methacrylic acid ester monomer”, and means one or both of these. For example, the term “methyl (meth)acrylate” means one or both of “methyl acrylate” and “methyl methacrylate”.

One or more of these (meth)acrylic acid ester monomers may be used. For example, it is possible to form a copolymer by using a styrene monomer and two or more acrylic acid ester monomers, to form a copolymer by using a styrene monomer and two or more methacrylic acid ester monomers, and to form a copolymer by using a styrene monomer, an acrylic acid ester monomer and a methacrylic acid ester monomer.

From the viewpoint of controlling the plasticity of the amorphous resin, a content of a constituent unit derived from the styrene monomer in the amorphous resin is preferably 40 to 90 mass %. Besides, a content of a constituent unit derived from the (meth)acrylic acid ester monomer in the amorphous resin is preferably 10 to 60 mass %.

The amorphous resin may further contain a constituent unit derived from another monomer in addition to the styrene monomer and the (meth)acrylic acid ester monomer. The another monomer is preferably a compound ester-bonded to a hydroxy group (—OH) derived from a polyhydric alcohol or a carboxy group (—COOH) derived from a polycarboxylic acid. Specifically, the amorphous resin is preferably a polymer obtained by further polymerizing a compound that is addition polymerizable with the styrene monomer and the (meth)acrylic acid ester monomer and has a carboxy group or a hydroxy group (i.e., an amphoteric compound).

Examples of the amphoteric compound include compounds having a carboxy group such as acrylic acid, methacrylic acid, maleic acid, itaconic acid, cinnamic acid, fumaric acid, maleic acid monoalkyl ester and itaconic acid monoalkyl ester; and compounds having a hydroxy group such as 2-hydroxyethyl (meth)acrylate, 2-hydroxypropyl (meth)acrylate, 3-hydroxypropyl (meth)acrylate, 2-hydroxybutyl (meth)acrylate, 3-hydroxybutyl (meth)acrylate, 4-hydroxybutyl (meth)acrylate and polyethylene glycol mono(meth)acrylate.

A content of a constituent unit derived from the amphoteric compound in the amorphous resin is preferably 0.5 to 20 mass %.

The styrene-acrylic resin can be synthesized by a method of polymerizing a monomer using a known oil-soluble or water-soluble polymerization initiator. Examples of the oil-soluble polymerization initiator include an azo-based or diazo-based polymerization initiator and a peroxide-based polymerization initiator.

Examples of the azo-based or diazo-based polymerization initiator include 2,2′-azobis-(2,4-dimethylvaleronitrile), 2,2′-azobisisobutylnitrile, 1,1′-azobis-(cyclohexane-1-carbonytrile), 2,2′-azobis-4-methoxy-2,4-dimethylvaleronitrile and azobisisobutyronitrile.

Examples of the peroxide-based polymerization initiator include benzoyl peroxide, methyl ethyl ketone peroxide, diisopropyl peroxycarbonate, cumene hydroperoxide, t-butyl hydroperoxide, di-t-butyl peroxide, dicumyl peroxide, 2,4-dichlorobenzoyl peroxide, lauroyl peroxide, 2,2-bis-(4,4-t-butylperoxycyclohexyl)propane and tris-(t-butylperoxy)triazine.

If a resin particle of the styrene-acrylic resin is synthesized by emulsion polymerization, a water-soluble radical polymerization initiator can be used as the polymerization initiator. Examples of the water-soluble polymerization initiator include persulfates such as potassium persulfate and ammonium persulfate, azobisaminodipropane acetate, azobiscyanovaleric acid and a salt thereof, and hydrogen peroxide.

From the viewpoint of controllability of the plasticity, the amorphous resin has a weight average molecular weight Mw of 5,000 to 150,000, and more preferably 10,000 to 70,000.

The crystalline resin refers to a resin having no step-like endothermic change but having a definite endothermic peak in the DSC of the crystalline resin or the toner particle. The term “definite endothermic peak” specifically means an endothermic peak having a half value of 15° C. or less in the DSC measured at a temperature rise rate of 10° C./min.

One or more crystalline resins may be used. The crystalline resin may be the same or different among the toners of the respective colors, and is preferably the same among the toners of the respective colors. Besides, the crystalline resin is preferably a crystalline polyester resin from the viewpoint of thermal characteristics involved in the low-temperature fixability.

A melting point Tm of the crystalline polyester resin is preferably 50 to 90° C., and more preferably 60 to 80° C. from the viewpoint of obtaining sufficient low-temperature fixability and high-temperature storage stability.

The melting point can be measured by the DSC. Specifically, 0.5 mg of a sample of the crystalline resin is enclosed in an aluminum pan “KITNO. B0143013”, the resultant pan is set in a sample holder of the thermal analyzer “Diamond DSC” (manufactured by PerkinElmer, Inc.), and the temperature is varied in order of heating, cooling and heating. In the first heating and the second heating, the temperature is increased from room temperature (25° C.) to 150° C. at a temperature rise rate of 10° C./min, and the temperature of 150° C. is kept for 5 minutes, and in the cooling, the temperature is decreased from 150° C. to 0° C. at a temperature drop rate of 10° C./min, and the temperature of 0° C. is kept for 5 minutes. A temperature of a peak top of an endothermic peak on an endothermic curve obtained in the second heating is measured as the melting point Tm.

Besides, the crystalline polyester resin contained in each of the chromatic color toners preferably has a weight average molecular weight Mw of 5,000 to 50,000 and a number average molecular weight Mn of 2,000 to 10,000 from the viewpoint of the low-temperature fixability and glossiness stably developed in a final image.

The weight average molecular weight of the crystalline resin contained in the black toner is preferably higher than that of the chromatic color toners by 3,000 to 20,000. If the weight average molecular weight Mw of the black toner falls in this range, the above-described relationships between the exothermic peak temperature of the black toner and the exothermic peak temperatures of the chromatic color toners can be easily obtained.

The weight average molecular weight Mw and the number average molecular weight Mn can be obtained based on a molecular weight distribution measured by gel permeation chromatography (GPC) as follows.

A sample is added to tetrahydrofuran (THF) into a concentration of 1 mg/mL, and the thus obtained solution is dispersed for 5 minutes at room temperature using a ultrasonic disperser, and the resultant solution is allowed to pass through a membrane filter having a pore size of 0.2 μm to prepare a sample solution. A GPC apparatus “HLC-8120 GPC” (manufactured by Tosoh Corporation) and columns “TSKguardcolumn and TSKgel Super HZ-m3 series” (manufactured by Tosoh Corporation) are used, and with the temperature of the columns kept at 40° C., THF is caused to flow as a carrier solvent at a flow rate of 0.2 mL/min. Together with the carrier solvent, 10 μL of the prepared sample solution is injected into the GPC apparatus, and the sample is detected using a refractive index detector (RI detector). Then, a molecular weight distribution of the sample is calculated based on a calibration curve precedently measured using ten points of a monodisperse polystyrene standard particle.

The content of the crystalline resin in a toner base particle of each color is preferably 5 to 20 mass % from the viewpoint of attaining both good low-temperature fixability and transferability under a high-temperature and high-humidity environment. If the content is smaller than 5 mass %, a toner image to be formed may be insufficient in the low-temperature fixability in some cases. If the content exceeds 20 mass %, the transferability may become insufficient in some cases.

The crystalline polyester resin is obtained by a polycondensation reaction between a di- or higher-valent carboxylic acid (polycarboxylic acid) and a di- or higher-hydric alcohol (polyhydric alcohol).

Examples of the polycarboxylic acid include dicarboxylic acids. One or more dicarboxylic acids may be used, an aliphatic dicarboxylic acid is preferably used, and an aromatic dicarboxylic acid may be further contained. The aliphatic dicarboxylic acid is preferably a straight chain dicarboxylic acid from the viewpoint of improving the crystallinity of the crystalline polyester resin.

Examples of the aliphatic dicarboxylic acid include oxalic acid, malonic acid, succinic acid, glutaric acid, adipic acid, pimelic acid, suberic acid, azelaic acid, sebacic acid, 1,9-nonandicarboxylic acid, 1,10-decanedicarboxylic acid, 1,11-undecanedicarboxylic acid, 1,12-dodecanedicarboxylic acid (dodecanedioic acid), 1,13-tridecanedicarboxylic acid, 1,14-tetradecanedicarboxylic acid, 1,16-hexadecanedicarboxyilc acid, 1,18-octadecanedicarboxylic acid, lower alkyl esters of these, and anhydrides of these. In particular, from the viewpoint of easily attaining both the low-temperature fixability and the transferability, aliphatic dicarboxylic acids having 6 to 16 carbon atoms is preferred, and aliphatic dicarboxylic acids having 10 to 14 carbon atoms are more preferred.

Examples of the aromatic dicarboxylic acid include terephthalic acid, isophthalic acid, orthophthalic acid, t-butyl isophthalic acid, 2,6-naphthalene dicarboxylic acid and 4,4′-biphenyl dicarboxylic acid. In particular, from the viewpoint of easiness in availability and emulsification, terephthalic acid, isophthalic acid or t-butyl isophthalic acid is preferably used.

In the crystalline polyester resin, a content of a constituent unit derived from the aliphatic dicarboxylic acid to a constituent unit derived from the dicarboxylic acid is preferably 50 mol % or more, more preferably 70 mol % or more, further preferably 80 mol % or more and particularly preferably 100 mol % from the viewpoint of sufficiently obtaining the crystallinity of the crystalline polyester resin.

An example of the polyhydric alcohol includes a diol. One or more diols may be used, an aliphatic diol is preferably used, and another diol may further be contained. The aliphatic diol is preferably a straight chain diol from the viewpoint of improving the crystallinity of the crystalline polyester resin.

Examples of the aliphatic diol include ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol and 1,20-eicosanediol. In particular, from the viewpoint of attaining both the low-temperature fixability and the transferability, an aliphatic diol having 2 to 120 carbon atoms is preferably used, and an aliphatic diol having 4 to 6 carbon atoms is more preferably used.

Other examples of the diol include a diol having a double bond and a diol having a sulfonic acid group. Specifically, examples of the diol having a double bond include 2-butene-1,4-diol, 3-butene-1,6-diol and 4-butene-1,8-diol.

A content of a constituent unit derived from an aliphatic diol to a constituent unit derived from a diol in the crystalline polyester resin is preferably 50 mol % or more, more preferably 70 mol % or more, further preferably 80 mol % or more and particularly preferably 100 mol % from the viewpoint of improving the low-temperature fixability of the toner and the glossiness of an image to be finally formed.

A ratio between the diol and the dicarboxylic acid in the monomer of the crystalline polyester resin is, in terms of an equivalent ratio [OH]/[COOH] between a hydroxy group [OH] of the diol and a carboxy group [COOH] of the dicarboxylic acid, preferably 2.0/1.0 to 1.0/2.0, more preferably 1.5/1.0 to 1.0/1.5, and particularly preferably 1.3/1.0 to 1.0/1.3.

The crystalline polyester resin can be synthesized by polycondensation (esterification) of the polycarboxylic acid and the polyhydric alcohol with a known esterification catalyst used.

As the catalyst usable in the synthesis of the crystalline polyester resin, one or more catalysts may be used, and examples include alkali metal compounds such as sodium and lithium; compounds containing a group 2 element such as magnesium and calcium; metal compounds such as aluminum, zinc, manganese, antimony, titanium, tin, zirconium and germanium; phosphorous acid compounds; phosphoric acid compounds; and amine compounds.

Specifically, examples of a tin compound includes dibutyltin oxide, tin octoate, tin dioctoate, and salts of these. Examples of a titanium compound include titanium alkoxides such as tetranormalbutyl titanate, tetraisopropyl titanate, tetramethyl titanate and tetrastearyl titanate; titanium acylates such as polyhydroxy titanium stearate; and titanium chelates such as titanium tetraacetylacetonate, titanium lactate, and titanium triethanol aluminate. An example of a germanium compound includes germanium dioxide, and examples of an aluminum compound include oxides such as polyaluminum hydroxide, aluminum alkoxide and tributyl aluminate.

A polymerization temperature of the crystalline polyester resin is preferably 150 to 250° C. Besides, a polymerization time is preferably 0.5 to 10 hours. During the polymerization, the reaction system may be placed in a reduced pressure state if necessary.

The crystalline polyester resin may contain a hybrid crystalline polyester resin (hereinafter sometimes simply referred to as the “hybrid resin”). One or more hybrid resins may be used. The hybrid resin may be replaced with the entire amount of the crystalline polyester resin, or replaced with a part of (namely, used together with) the crystalline polyester resin.

The hybrid resin is a resin in which a crystalline polyester resin unit segment and an amorphous resin unit segment are chemically bonded to each other. The crystalline polyester resin unit segment means a portion derived from the crystalline polyester resin. In other words, it means a molecular chain having the same chemical structure as a molecular chain constituting the crystalline polyester resin. The amorphous resin unit segment means a portion derived from the amorphous resin. In other words, it means a molecular chain having the same chemical structure as a molecular chain constituting the amorphous resin.

A weight average molecular weight Mw of the hybrid resin is preferably 5,000 to 100,000, more preferably 7,000 to 50,000, and particularly preferably 8,000 to 20,000 from the viewpoint of definitely attaining both sufficient low-temperature fixability and excellent long-term storage stability. If the weight average molecular weight Mw of the hybrid resin is 100,000 or less, the sufficient low-temperature fixability can be obtained. In contrast, if the weight average molecular weight Mw of the hybrid resin is 5,000 or more, the hybrid resin and the amorphous resin can be inhibited from becoming excessively compatible with each other during the storage of the toner, and an image failure due to fusion of the toner can be effectively inhibited.

The crystalline polyester resin unit segment may be, for example, a resin having a structure in which a main chain of the crystalline polyester resin unit segment is copolymerized with another component, or a resin having a structure in which a main chain of another component is copolymerized with the crystalline polyester resin unit segment. The crystalline polyester resin unit segment can be synthesized from the polycarboxylic acid and the polyhydric alcohol in the same manner as the crystalline polyester resin described above.

A content of the crystalline polyester resin unit segment in the hybrid resin is preferably 80 mass % or more and less than 98 mass %, more preferably 90 mass % or more and less than 95 mass %, and particularly preferably 91 mass % or more and less than 93 mass % from the viewpoint of imparting sufficient crystallinity to the hybrid resin. A constituent component and a content of each unit segment in the hybrid resin (or in the toner) can be specified by any of known analysis methods such as nuclear magnetic resonance (NMR) and methylation pyrolysis gas chromatography/mass spectrometry (P-GC/MS).

The crystalline polyester resin unit segment preferably further contains a monomer having an unsaturated bond from the viewpoint of introducing, into this segment, a chemical binding site to the amorphous resin unit segment. An example of the monomer having an unsaturated bond includes a polyhydric alcohol having a double bond, and specific examples include polycarboxylic acids having a double bond such as methylenesuccinic acid, fumaric acid, maleic acid, 3-hexenedioic acid and 3-octenedioic acid; 2-butene-1,4-diol, 3-butene-1,6-diol and 4-butene-1,8-diol. A content of a constituent unit derived from the monomer having an unsaturated bond in the crystalline polyester resin unit segment is preferably 0.5 to 20 mass %.

The hybrid resin may be a block copolymer or a graft copolymer, and is preferably a graft copolymer from the viewpoint that the orientation of the crystalline polyester resin unit segment can be easily controlled and sufficient crystallinity can be imparted to the hybrid resin. More preferably, the crystalline polyester resin unit segment is grafted using the amorphous resin unit segment as a main chain. In other words, the hybrid resin is preferably a graft copolymer having a main chain of the amorphous resin unit segment and a side chain of the crystalline polyester resin unit segment.

Into the hybrid resin, a functional group such as a sulfonic acid group, a carboxy group or a urethane group may be introduced. The functional group may be introduced into the crystalline polyester resin unit segment or the amorphous resin unit segment.

The amorphous resin unit segment increases affinity between the amorphous resin and the hybrid resin constituting the binder resin. Owing to this segment, the hybrid resin can be easily incorporated into the amorphous resin, and hence the charge evenness of the toner can be further improved. A constituent component and a content of the amorphous resin unit segment in the hybrid resin (or in the toner) can be specified by, for example, any of known analysis methods such as the NMR and the methylation P-GC/MS.

In the amorphous resin unit segment, the glass transition temperature Tg1 obtained in the first temperature rise process in the DSC is preferably 30 to 80° C. and more preferably 40 to 65° C. as in the amorphous resin described above. The glass transition temperature Tg1 can be measured by the above-described method.

From the viewpoint of improving the affinity with the binder resin and the charge evenness of the toner, the amorphous resin unit segment is preferably constituted by a resin of the same type as the amorphous resin contained in the binder resin. In this aspect, the affinity between the hybrid resin and the amorphous resin is further improved. The term “resins of the same type” means resins having the same characteristic chemical bond in their repeating units.

The term “characteristic chemical bond” complies with “Polymer Classification” described in National Institute for Materials Science (NIMS) Materials Database (http://polymer.nims.go.jp/PoLyInfo/guide/jp/terms_polymer.html). Specifically, a chemical bond constituting 22 polymers in total, that is, polyacrylic, polyamide, polyanhydride, polycarbonate, polydiene, polyester, polyhaloolefin, polyimide, polyimine, polyketone, polyolefin, polyether, polyphenylene, polyphosphazene, polysiloxane, polystyrene, polysulfide, polysulfone, polyurethane, polyurea, polyvinyl and another polymer, is defined as the “characteristic chemical bond”.

If the resin is a copolymer, when the copolymer contains, as a constituent unit, monomer species having the above-described chemical bond in chemical structures of a plurality of monomer species constituting the copolymer, “resins of the same type” means resins commonly having the characteristic chemical bond. Accordingly, even when resins have different characteristics from each other or molar component ratios between monomer species constituting copolymers are different, resins commonly having the characteristic chemical bond are regarded as the resins of the same type.

For example, a resin (or a resin unit segment) formed by styrene, butyl acrylate and acrylic acid and a resin (or a resin unit segment) formed by styrene, butyl acrylate and methacrylic acid are resins of the same type because they commonly have a chemical bond constituting polyacrylic. Besides, a resin (or a resin unit segment) formed by styrene, butyl acrylate and acrylic acid and a resin (or a resin unit segment) formed by styrene, butyl acrylate, acrylic acid, terephthalic acid and fumaric acid have, as a common chemical bond, at least a chemical bond constituting polyacrylic, and hence are regarded as resins of the same type.

Examples of the amorphous resin unit segment include a vinyl resin unit, a urethane resin unit and a urea resin unit. In particular, a vinyl resin unit is preferred from the viewpoint of easy controllability of thermoplasticity. The vinyl resin unit can be synthesized in the same manner as the vinyl resin described above.

A content of a constituent unit derived from the styrene monomer in the amorphous resin unit segment is preferably 40 to 90 mass % from the viewpoint of easy controllability of the plasticity of the hybrid resin. From a similar point of view, a content of a constituent unit derived from the (meth)acrylic acid ester monomer in the amorphous resin unit segment is preferably 10 to 60 mass %.

From the viewpoint that the chemical binding site to the crystalline polyester resin unit segment is introduced into the amorphous resin unit segment, the amorphous resin unit segment preferably further contains the amphoteric compound described above. A content of a constituent unit derived from the amphoteric compound in the amorphous resin unit segment is preferably 0.5 to 20 mass %.

A content of the amorphous resin unit segment in the hybrid resin is preferably 3 mass % or more and less than 15 mass %, more preferably 5 mass % or more and less than 10 mass %, and further preferably 7 mass % or more and less than 9 mass % from the viewpoint of imparting sufficient crystallinity to the hybrid resin.

The hybrid resin can be produced, for example, any of the following first to third production processes.

In the first production process, a polymerization reaction for synthesizing a crystalline polyester resin unit segment in the presence of a precedently synthesized amorphous resin unit segment is performed for producing a hybrid resin.

In this process, an amorphous resin unit is first synthesized by an addition reaction of the above-described monomer constituting the amorphous resin unit segment (preferably, a vinyl monomer such as a styrene monomer or a (meth)acrylic acid ester monomer). Next, in the presence of the amorphous resin unit segment, a polycarboxylic acid and a polyhydric alcohol are polymerized to synthesize a crystalline polyester resin unit segment. Here, the polycarboxylic acid and the polyhydric alcohol are subjected to condensation as well as the amorphous resin unit segment is subjected to an addition reaction to the polycarboxylic acid or the polyhydric alcohol, so as to synthesize a hybrid resin.

In the first process, into the crystalline polyester resin unit segment or the amorphous resin unit segment, a site capable of a reaction between these unit segments is preferably incorporated. Specifically, in synthesizing the amorphous resin unit segment, the above-described amphoteric compound is used in addition to a monomer constituting the amorphous resin unit segment. The amphoteric compound is reacted with a carboxy group or a hydroxy group contained in the crystalline polyester resin unit segment, and hence the crystalline polyester resin unit segment chemically and quantitatively bonds to the amorphous resin unit segment. Besides, in synthesizing the crystalline polyester resin unit segment, the monomer may be caused to contain the compound having an unsaturated bond described above.

Through the first process, a hybrid resin having a structure in which the crystalline polyester resin unit segment is molecularly bonded to the amorphous resin unit segment (i.e., a graft structure) can be synthesized.

In the second process, a crystalline polyester resin unit segment and an amorphous resin unit segment are respectively formed, and these segments are bonded to each other to produce a hybrid resin.

In this process, a crystalline polyester resin unit segment is first synthesized by condensation of a polycarboxylic acid and a polyhydric alcohol. Besides, separately from the reaction system for synthesizing the crystalline polyester resin unit segment, an amorphous resin unit segment is synthesized by addition polymerization of the above-described monomer constituting the amorphous resin unit segment. Here, into one of or both of the crystalline polyester resin unit segment and the amorphous resin unit segment, a site capable of a reaction between the crystalline polyester resin unit segment and the amorphous resin unit segment is preferably incorporated as described above.

Next, the crystalline polyester resin unit segment and the amorphous resin unit segment synthesized as above are reacted with each other, and thus, a hybrid resin having a structure in which the crystalline polyester resin unit segment and the amorphous resin unit segment are molecularly bonded to each other can be synthesized.

If the site capable of the reaction is incorporated into neither the crystalline polyester resin unit segment nor the amorphous resin unit segment, a compound having a site capable of bonding both the crystalline polyester resin unit segment and the amorphous resin unit segment may be added to a system in which both the crystalline polyester resin unit segment and the amorphous resin unit segment coexist. In this manner, a hybrid resin having a structure in which the crystalline polyester resin unit segment and the amorphous resin unit segment are molecularly bonded via the compound can be synthesized.

In the third production process, a hybrid resin is produced by performing a polymerization reaction for synthesizing an amorphous resin unit segment in the presence of a crystalline polyester resin unit segment.

In this process, a crystalline polyester resin unit segment is first synthesized by performing polymerization through condensation of a polycarboxylic acid and a polyhydric alcohol. Next, in the presence of the crystalline polyester resin unit segment, a monomer constituting an amorphous resin unit segment is polymerized to synthesize the amorphous resin unit segment. Here, into the crystalline polyester resin unit segment or the amorphous resin unit segment, a site capable of a reaction between these unit segments is preferably incorporated in the same manner as in the first production process described above.

In this manner, a hybrid resin having a structure in which the amorphous resin unit segment is molecularly bonded to the crystalline polyester resin unit segment (i.e., the graft structure) can be synthesized.

Among the first to third production processes, the first production process is preferably employed because a hybrid resin having a structure in which a crystalline polyester resin chain is grafted to an amorphous resin chain can be easily synthesized and production procedures can be simplified. Since the amorphous resin unit segment is precedently formed before binding to the crystalline polyester resin unit segment in the first production process, the orientation of the crystalline polyester resin unit segment can be easily made uniform. Accordingly, this production process is preferred from the viewpoint that a hybrid resin suitable to the toner of each color can be definitely synthesized.

The toner of each color contains a colorant. One or more of colorants may be used.

Among the toners of the respective colors, the black toner uses a colorant containing a conductive black colorant. Examples of the conductive black colorant include carbon black and a magnetic particle. Examples of the carbon black include channel black, furnace black, acetylene black, thermal black and lamp black. Examples of a magnetic material of the magnetic particle include ferromagnetic metals such as iron, nickel and cobalt; alloys containing any of these ferromagnetic metals, and compounds of the ferromagnetic metals such as ferrite and magnetite; chromium dioxide; and alloys not containing the ferromagnetic metals but exhibiting ferromagnetism when heated. Examples of the alloys exhibiting ferromagnetism when heated include Heusler alloys such as manganese-copper-aluminum and manganese-copper-tin. The colorant of the black toner may contain a non-conductive black colorant as long as the effects of the present embodiment can be obtained.

The magenta toner contains a magenta or red colorant. Examples of the magenta or red colorant include C.I. pigment red 2, 3, 5, 6, 7, 15, 16, 48:1, 53:1, 57:1, 60, 63, 64, 68, 81, 83, 87, 88, 89, 90, 112, 114, 122, 123, 139, 144, 149, 150, 163, 166, 170, 177, 178, 184, 202, 206, 207, 209, 222, 238 and 269.

The yellow toner contains an orange or yellow colorant. Examples of the orange or yellow colorant include C.I. pigment orange 31 and 43, and C.I. pigment yellow 12, 14, 15, 17, 74, 83, 93, 94, 138, 155, 162, 180 and 185.

The cyan toner contains a green or cyan colorant. Examples of the green or cyan colorant include C.I. pigment blue 2, 3, 15, 15:2, 15:3, 15:4, 16, 17, 60, 62 and 66, and C.I. pigment green 7.

An addition amount of the colorant in each of the black toner and the chromatic color toners can be appropriately and independently determined, and is, for example, preferably 1 to 30 mass % and more preferably 2 to 20 mass % from the viewpoint of attaining color reproducibility of an image. Besides, the size of a particle of the colorant is, in terms of a volume average particle size, preferably 10 to 1,000 nm, more preferably 50 to 500 nm, and further preferably 80 to 300 nm. The volume average particle size may be a catalog value, or for example, a volume average particle size (a median diameter based on a volume) of a colorant can be measured using “UPA-150” (manufactured by MicrotracBEL Corp.).

The toner of each color may further contain an additional component in addition to the amorphous resin, the crystalline resin and the colorant as long as the effects of the present embodiment can be exhibited. Examples of the additional component include a release agent and a charge control agent.

As the release agent, any of known agents can be used. Examples include branched chain hydrocarbon waxes such as polyolefin waxes like polyethylene wax and polypropylene wax, and microcrystalline waxes; long chain hydrocarbon waxes such as paraffin wax and Sasol wax; dialkyl ketone waxes such as distearyl ketone, carnauba wax, montan wax, and ester waxes such as behenyl behenate, trimethylolpropane tribehenate, pentaerythritol tetrabehenate, pentaerythtritol diacetate dibehenate, glycerin tribehenate, 1,18-octadecanediol distearate, tristearyl trimellitate and distearyl maleate; and amide waxes such as ethylenediamine behenylamide and tristearylamide trimellitate.

From the viewpoint of sufficiently attaining the high-temperature storage stability of the toner and improving stability of toner image formation by inhibiting occurrence of a cold offset in fixing at a low temperature, the release agent has a melting point of preferably 40 to 160° C., and more preferably 50 to 120° C. Besides, a content of the release agent in the toner of each color is preferably 1 to 30 mass % and more preferably 5 to 20 mass %.

A content of the release agent in the black toner is preferably smaller than that in the chromatic color toners by 5 to 20 mass % from the viewpoint of attaining the above-described good relationships between the exothermic peak temperature of the black toner and the exothermic peak temperatures of the chromatic color toners.

As the charge control agent, any of know agents can be used, and examples include a nigrosine-based dye, a metal salt of naphthenic acid or a higher fatty acid, alkoxylated amine, quaternary ammonium chloride, an azo-based metal complex and a metal salt of salicylic acid. A content of the charge control agent in the toner of each color is generally 0.1 to 10 parts by mass relative to 100 parts by mass of the binder resin, and is preferably 0.5 to 5 mass %. The size of a particle of the charge control agent is, in terms of a number average primary particle size, for example, 10 to 1,000 nm, preferably 50 to 500 nm, and more preferably 80 to 300 nm.

The toner of each color may further contain, in addition to the above-described internal additive, an external additive such as an inorganic fine particle, an organic fine particle or a lubricant from the viewpoint of improving charging performance or flow ability as the toner or a cleaning property by adhering to the surface of the toner base particle. One or more external additives may be contained. A toner base particle (toner particle) having an external additive adhering to the surface thereof can constitute a one-component developer.

Examples of an inorganic compound corresponding to the material of the inorganic fine particle include silica, titania, alumina and strontium titanate. The inorganic fine particle may be hydrophobized, if necessary, with a known surface treating agent such as a silane coupling agent or silicone oil. The size of the inorganic fine particle is, in terms of a number average primary particle size, preferably 20 to 500 nm, and more preferably 70 to 300 nm.

As the organic fine particle, an organic fine particle of a single polymer of styrene or methyl methacrylate or a copolymer of these can be used. The size of the organic fine particle is, in terms of a number average primary particle size, about 10 to 2,000 nm, and the shape is, for example, spherical.

The lubricant is used for purposes of further improving the cleaning property and the transferability. An example of the lubricant includes a metal salt of a higher fatty acid, and specific examples include salts, such as zinc, aluminum, copper, magnesium and calcium, of stearic acid; salts, such as zinc, manganese, iron, copper and magnesium, of oleic acid; salts, such as zinc, copper, magnesium and calcium, of palmitic acid; salts, such as zinc and calcium, of linolic acid; and salts, such as zinc and calcium, of ricinoleic acid. The size of a particle of the lubricant is, in terms of a medium diameter based on the volume (a volume average particle size), preferably 0.3 to 20 μm, and more preferably 0.5 to 10 m.

The median diameter based on the volume of the lubricant can be obtained in accordance with JIS Z8825-1 (2013). Specifically, the measurement is performed as follows.

As a measurement apparatus, a laser diffraction/scattering particle size distribution analyzer “LA-920” (manufactured by Horiba, Ltd.) is used. Software “HORIBA LA-920 for Windows (R) WET (LA-920) Ver. 2.02” attached to the analyzer LA-920 is used for setting measurement conditions and analyzing measurement data. Besides, ion-exchanged water from which solid impurities and the like are precedently removed is used as a measurement solvent.

The measurement includes the following procedures (1) to (11):
(1) A batch type cell holder is attached to the analyzer LA-920.
(2) A prescribed amount of ion-exchanged water is put in a batch type cell, and the batch type cell is set in the batch type cell holder.
(3) The content of the batch type cell is stirred using a specialized stirrer tip.
(4) A “Refractive Index” button on a “Condition Setting” screen is pressed to select a file “110A000I” (relative refractive index 1.10).
(5) In the “Condition Setting” screen, the base of the particle size measurement is set to volume base.
(6) After performing a warm-up operation for 1 hour or more, adjustment and fine adjustment of an optical axis, and blank measurement are performed.
(7) A 100 mL glass flat bottom beaker is charged with about 60 mL of ion-exchanged water. To the resultant beaker, about 0.3 mL of a diluted solution obtained by diluting “Contaminon N” (a 10 mass % aqueous solution of a neutral detergent for washing precision measuring instruments of pH 7 containing a nonionic surfactant, an anionic surfactant and an organic builder, manufactured by Wako Pure Chemical Industries Ltd.) about 3-fold in mass with ion-exchanged water is added.
(8) An ultrasonic disperser “Ultrasonic Dispersion System Tetora 150” (manufactured by Nikkaki Bios Co., Ltd.) with an electrical power output of 120 W in which two oscillators having an oscillation frequency of 50 kHz are disposed with their phases shifted by 180 degrees is prepared. A water tank of the ultrasonic disperser is charged with about 3.3 L of ion-exchanged water, and about 2 mL of Contaminon N is added into the water tank.
(9) The beaker of (7) described above is set in a beaker fixing hole of the ultrasonic disperser, and the ultrasonic disperser is actuated. Then, the position of the beaker is adjusted so that the liquid surface of the aqueous solution contained in the beaker can be placed in the maximum resonance state.
(10) With the aqueous solution contained in the beaker of (9) described above irradiated with ultrasonic waves, about 1 mg of the lubricant particle is added in small aliquots to the aqueous solution in the beaker to be dispersed therein. Thereafter, the ultrasonic dispersion is continued for further 60 seconds. Here, although the lubricant particle may float on the liquid surface in the form of a lump in some cases, the beaker is shaken to sink the lump in such a case before performing the ultrasonic dispersion for 60 seconds. Besides, in performing the ultrasonic dispersion, the temperature of the solution in the water tank is appropriately adjusted to 10° C. or more and 40° C. or less.
(11) The resultant aqueous solution in which the lubricant particle is dispersed prepared in (10) above is immediately added, in small aliquots, into the batch type cell carefully not to introduce bubbles, and the concentration of the dispersion obtained as described above is adjusted so as to attain transmittance of light emitted from a tungsten lump of 90% to 95%. Then, a particle size distribution is measured. On the basis of data of the particle size distribution based on the volume thus obtained, a 50% volume-cumulative particle size is obtained, which is defined as the median diameter based on the volume of the lubricant particle.

The particle size of the external additive may be a catalog value or an actually measured value. The volume average particle size of the external additive can be obtained as follows: One hundred primary particles of the external additive disposed on the toner base particle are observed with a scanning electron microscope (SEM), the longest diameter and the shortest diameter of an individual external additive particle are measured by image analysis of the observed primary particles, a median of these diameters are used to obtain a sphere equivalent diameter, and the volume average particle size can be obtained as a diameter D50v at a cumulative frequency of 50% of the thus obtained sphere equivalent diameters. The volume average particle size of the external additive can be adjusted by, for example, grinding a coarse product, classification or mixing with a classified product.

A content of the external additive in the toner of each color is preferably 0.1 to 10.0 parts by mass relative to 100 parts by mass of the toner particle. The external additive may be added to the toner base particle using any of various known mixers such as a tubular mixer, a Henschel mixer, a Nauta mixer and a V-shaped mixer.

The toner of each color may further contain a carrier particle. The toner of each color containing a carrier particle in addition to the toner particle constitutes a two-component developer.

The carrier particle includes a magnetic particle. Examples of a magnetic material of the magnetic particle include known materials including metals such as iron, ferrite and magnetite; and alloys of these metals with another metal such as aluminum or lead. In particular, the magnetic particle is preferably a ferrite particle.

The carrier particle may be a resin-coated carrier particle containing the magnetic particle and a resin layer coating its surface, or a magnetic material dispersion carrier particle containing a resin particle in which a fine particle of the magnetic material is dispersed. Examples of the resin used for coating in the resin-coated carrier particle include an olefin resin, a cyclohexyl methacrylate-methyl methacrylate copolymer, a styrene resin, a styrene-acrylic resin, a silicone resin, an ester resin and a fluorine resin. Examples of the resin used for constituting the resin particle in the magnetic material dispersion carrier particle include an acrylic resin, a styrene-acrylic resin, a polyester resin, a fluorine resin and a phenol resin.

The size of the carrier particle is, in terms of a volume average particle size, preferably 15 to 100 μm, and more preferably 25 to 60 μm. A content of the carrier particle in the toner of each color is, for example, an amount corresponding to a toner particle concentration of 6 to 8 mass %. Besides, the volume average particle size of the carrier particle can be measured in the same manner as, for example, the particle size of the external additive.

The average particle size of the toner particle is, in terms of the volume average particle size, preferably 3.0 to 8.0 μm, and more preferably 4.0 to 7.5 μm from the viewpoint of inhibiting the occurrence of fixing offset caused by scattering of the toner onto a heating member in fixing, the viewpoint of improving transfer efficiency, and the viewpoint of improving the flowability of the toner. The average particle size of the toner particle can be obtained by measuring the volume average particle size using “Coulter Multisizer 3” (manufactured by Beckman Coulter Inc.), and can be controlled in accordance with the concentration of a coagulant and the addition amount of a solvent employed in agglomerating and fusing steps in the production of the toner of each color, the fusing time in the agglomerating and fusing steps, or the composition of the binder resin.

An average circularity of the toner particle is preferably 0.920 to 1.000 and more preferably 0.940 to 0.995 from the viewpoint of improving the transfer efficiency. The average circularity is represented by the following equation. In the equation, L0 represents a perimeter (μm) of a projected image of the particle, and L1 represents a perimeter (μm) of a circle obtained based on a circle equivalent diameter of the particle. The average circularity can be measured, for example, using an average circularity measurement apparatus “FPIA-2100” (manufactured by Sysmex Corporation).

Average circularity=L1/L0

### Toner Production Process

A process for producing the toner particle is not limited, and examples include known polymerization methods such as suspension polymerization, emulsion polymerization agglomeration, and dispersion polymerization. The toner particle may be a particle having a core/shell structure in which a surface of a core particle made of a core resin is coated with a shell layer made of a shell resin, or may be a single-layered particle not having such a shell layer. If the toner particle is a particle having the core/shell structure, the shell resin constituting the shell layer is preferably an amorphous resin.

A dried toner base particle obtained by the production process of the toner particle can be directly used as the toner, or a known external additive may be added thereto by a dry method for adding and mixing the external additive, so as to use the resultant as the toner of the present invention. As a mixer used for adding and mixing the external additive, any of various known mixers such as a tubular mixer, a Henschel mixer, a Nauta mixer and a V-shaped mixer can be used.

Now, a specific production process of the toner will be described by exemplifying the production of the yellow toner. In the production of the toner different from the yellow toner, for example, the magenta toner, the cyan toner or the black toner, the production process of the yellow toner can be suitably employed merely by changing the colorant to be used. It is noted that the toner production process of the present invention is not limited to the following.

<Preparation of Aqueous Dispersion of Colorant Fine Particle>

Sodium dodecyl sulfate is dissolved in ion-exchanged water under stirring, a yellow colorant is added to and dispersed in the thus obtained aqueous solution, and thus, an aqueous dispersion of a colorant fine particle in which a fine particle of the yellow colorant is dispersed is prepared.

<Preparation of Aqueous Dispersion of Release Agent-Containing Amorphous Vinyl Polymer>

(First Polymerization)

A reaction vessel equipped with a stirring device, a temperature sensor, a condenser and a nitrogen introducing device is charged with sodium dodecyl sulfate and ion-exchanged water, and the temperature is increased with stirring under a nitrogen stream, and an initiator aqueous solution obtained by dissolving potassium persulfate in ion-exchanged water is added thereto. To the resultant, a monomer mixed solution containing, for example, styrene (St) as the styrene monomer, n-butyl acrylate (BA) as the (meth)acrylic acid ester monomer, and methacrylic acid (MAA) as the compound having a carboxy group [—COOH] or a hydroxy group [—OH] is added in a dropwise manner, and the resultant solution was heated and stirred for performing polymerization, and thus, resin fine particle dispersion 1 is prepared.

(Second Polymerization)

A reaction vessel equipped with a stirring device, a temperature sensor, a condenser and a nitrogen introducing device is charged with a solution obtained by dissolving sodium polyoxyethylene (2) dodecyl ether sulfate in ion-exchanged water, followed by heating. To the resultant, resin fine particle dispersion 1 described above and a solution in which monomers and a release agent are dissolved, for example, a solution containing styrene (St) as the styrene monomer, n-butyl acrylate as the (meth)acrylic acid ester monomer, methacrylic acid (MAA) as the compound having a carboxy group [—COOH] or a hydroxy group [—OH], n-octyl 3-mercaptopropionate, release agent (behenyl behenate (having a melting point of 73° C.)) and the like is added to be mixed and dispersed therein, and thus, a dispersion containing an emulsion particle (an oil droplet) is prepared.

Subsequently, an initiator aqueous solution obtained by dissolving potassium persulfate in ion-exchanged water is added to the dispersion, and the resultant system is heated and stirred for performing polymerization, and thus, resin fine particle dispersion 2 is prepared.

(Third Polymerization)

Ion-exchanged water is added to and well mixed with resin fine particle dispersion 2, and an initiator aqueous solution obtained by dissolving potassium persulfate in ion-exchanged water is added to the resultant. To the thus obtained solution, a monomer mixed solution containing, for example, styrene (St) as the styrene monomer, n-butyl acrylate (BA) as the (meth)acrylic acid ester monomer, methacrylic acid (MMA) as the compound having a carboxy group [—COOH] or a hydroxy group [—OH], n-octyl 3-mercaptopropionate and the like is added in a dropwise manner. After completing the dropwise addition, the resultant was heated and stirred for performing polymerization, followed by cooling, and thus, an aqueous dispersion of a release agent-containing amorphous vinyl polymer is prepared.

<Preparation of Aqueous Dispersion of Crystalline Polyester Resin>

(Synthesis of Crystalline Polyester Resin)

As material monomers and a radical polymerization initiator of a resin segment for the addition polymerization system (here, a styrene/acrylic resin segment), for example, styrene, n-butyl acrylate, acrylic acid and a polymerization initiator (di-t-butyl peroxide) are put in a dropping funnel.

As material monomers of a resin segment for the polycondensation system (here, a crystalline polyester resin segment), for example, sebacic acid, that is, one of aliphatic dicarboxylic acids, and 1,12-dodecanediol, that is, one of aliphatic diols, are put in a four-necked flask equipped with a nitrogen introducing tube, a dehydration tube, a stirrer and a thermocouple, so as to be heated and dissolved.

Subsequently, the material monomers and the radical polymerization initiator of the resin segment for the addition polymerization system having been put in the dropping funnel are added in a dropwise manner under stirring into the heated and dissolved material solution of the resin segment for the polycondensation system, the resultant is aged, and unreacted portions of the addition polymerization monomers are removed under reduced pressure. Thereafter, an esterification catalyst is added thereto, and the temperature is increased to cause a reaction under normal pressure, and further cause a reaction under reduced pressure. The resultant is cooled, then reacted under reduced pressure, and thus, a crystalline polyester resin corresponding to a hybrid resin is obtained.

(Preparation of Aqueous Dispersion of Crystalline Polyester Resin)

The crystalline polyester resin obtained as described above is dissolved in a solvent (such as methyl ethyl ketone) under stirring. Subsequently, to the thus obtained solution, a sodium hydroxide aqueous solution is added. To the resultant solution, water is added in a dropwise manner to be mixed under stirring to prepare an emulsion. Then, the solvent is removed by distillation from the emulsion, and thus, an aqueous dispersion in which the crystalline polyester resin is dispersed is prepared.

<Preparation of Aqueous Dispersion of Amorphous Polyester Resin>

(Synthesis of Amorphous Polyester Resin)

A reaction vessel equipped with a nitrogen introducing tube, a dehydration tube, a stirrer and a thermocouple is charged with, for example, a bisphenol A propylene oxide 2-mol adduct, terephthalic acid, fumaric acid and an esterification catalyst (such as tin octoate) to be condensation polymerized, and the resultant is further reacted under reduced pressure and cooled.

Subsequently, a mixture of, for example, acrylic acid used as the compound having a carboxy group [—COOH] or a hydroxy group [—OH], styrene used as the styrene monomer, butyl acrylate used as the (meth)acrylic acid ester monomer, and di-t-butyl peroxide used as the polymerization initiator is added in a dropwise manner into the reaction vessel. After the dropwise addition, the resulting solution was addition polymerized, and the temperature is increased and retained under reduced pressure, and then, the compound having a carboxy group [—COOH] or a hydroxy group [—OH], the styrene monomer and the (meth)acrylic acid ester monomer are removed. In this manner, an amorphous polyester resin in which a vinyl resin segment and a crystalline polyester resin segment are bonded to each other is synthesized.

(Preparation of Aqueous Dispersion of Amorphous Polyester Resin)

The amorphous polyester resin obtained as described above is dissolved in a solvent (such as methyl ethyl ketone) under stirring. Next, a sodium hydroxide aqueous solution is added to the thus obtained solution. Water is added thereto in a dropwise manner under stirring to prepare an emulsion. The solvent is removed from the emulsion by distillation, and thus, an aqueous dispersion in which the amorphous polyester resin is dispersed is prepared.

<Production of Yellow Toner>

A reaction vessel equipped with a stirring device, a temperature sensor and a condenser is charged with the aqueous dispersion of the release agent-containing amorphous vinyl polymer and ion-exchanged water, and a sodium hydroxide aqueous solution is added thereto to adjust pH of the resultant solution.

Thereafter, the reaction vessel is charged with the aqueous dispersion of the colorant fine particle, and a magnesium chloride aqueous solution is added thereto to prepare a mixed solution. The mixed solution is heated, and the aqueous dispersion of the crystalline polyester resin is further added to the mixed solution to cause agglomeration to proceed. When an agglomerated particle attains a desired particle size, the aqueous dispersion of the amorphous polyester resin is added thereto, and an aqueous solution obtained by dissolving sodium chloride in ion-exchanged water is added thereto to stop the growth of the particle. Thereafter, the mixed solution is heated under stirring to fuse the particle. Thereafter, the resultant solution is cooled.

Next, the mixed solution is subjected to solid-liquid separation, the thus obtained solid component (i.e., a toner base particle) is washed and then dried to obtain a yellow toner base particle. An external additive is added to the obtained toner base particle, and thus, a yellow toner particle is produced.

(Production Process of Yellow Toner)

The yellow toner particle is mixed with a known ferrite carrier in an amount corresponding to a toner concentration of 6 to 8 mass %, and thus, a yellow toner is produced.

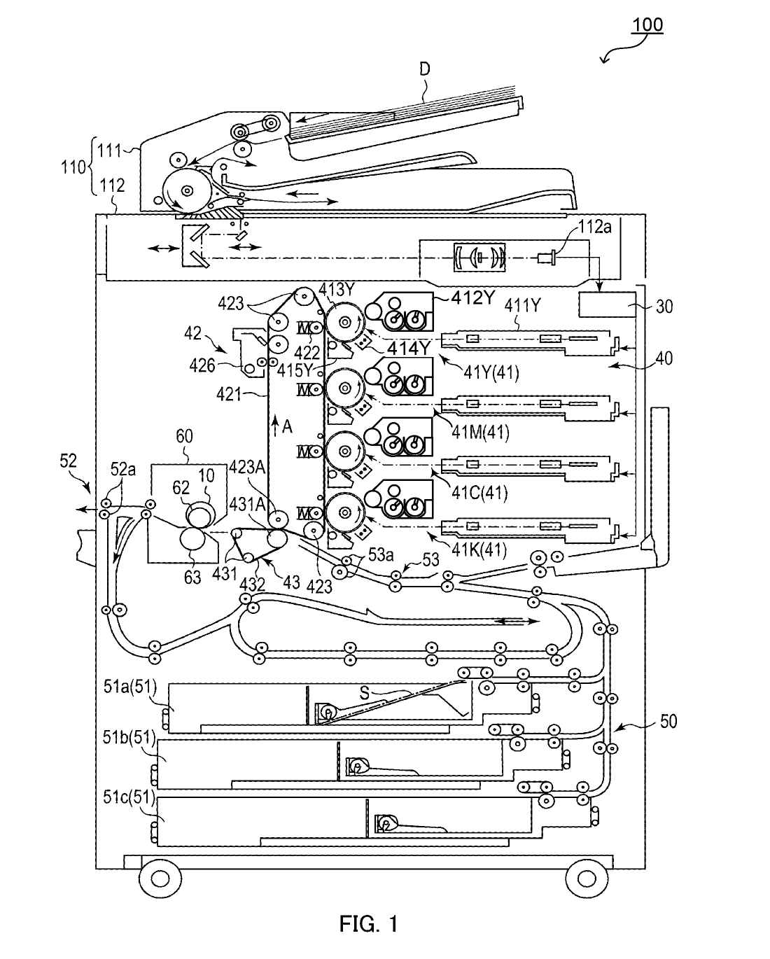

The toner set is applied to a general electrophotographic image forming method to develop an electrostatic latent image. The toner set is contained in, for example, an image forming apparatus as illustrated in FIG. 1 to be used in formation of a toner image on a recording medium.

Image forming apparatus 100 of FIG. 1 includes image reading section 110, image processing section 30, image forming section 40, sheet conveying section 50 and fixing device 60.

Image forming section 40 includes image forming units 41Y, 41M, 41C and 41K respectively forming images of toners of respective colors of Y (yellow), M (magenta), C (cyan) and K (black). These toners are two-component developers each containing a toner particle and a carrier particle, and satisfy the above-described expressions 1-1 to 1-3, and correspond to the toner of the present embodiment. These image forming units 41Y, 41M, 41C and 41K have the same structure excluding the color of the toner contained therein, and hence are hereinafter sometimes referred to without using a sign corresponding to the color. Image forming section 40 further includes intermediate transfer unit 42 and secondary transfer unit 43. These units correspond to a transfer device.

Each image forming unit 41 includes exposing device 411, developing device 412, photoconductor drum 413, charging device 414 and cleaning device 415. Photoconductor drum 413 is, for example, a negative charge type organic photoconductor. The surface of photoconductor drum 413 is photoconductive. Photoconductor drum 413 corresponds to a photoconductor. Charging device 414 is, for example, a corona charger. Charging device 414 may be a contact charging device for charging photoconductor drum 413 by bringing a contact charging member, such as a charging roller, a charging brush or a charging blade, into contact with photoconductor drum 413. Exposing device 411 includes, for example, a semiconductor laser serving as a light source, and an optical deflecting device (polygon motor) irradiating photoconductor drum 413 with a laser beam in accordance with an image to be formed.

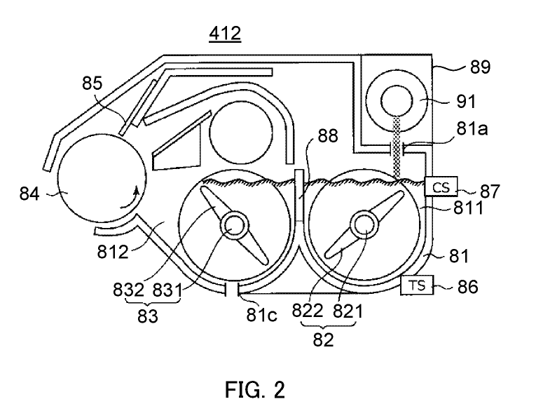

Developing device 412 is a two-component development type developing device as illustrated in FIG. 2. Developing device 412 includes developer container 81, stirring screw 82, supply screw 83, developing roller 84, developer restriction member 85, toner density sensor 86, carrier detection sensor 87 and toner supply section 89.

Developer container 81 contains the two-component developer. Developer container 81 includes partition 88 that is disposed between stirring screw 82 and supply screw 83 for dividing the inside of developer container 81 into developer stirring path 811 and developer supply path 812 extending in parallel to the axial direction of developing roller 84. Developer outlet 81c is provided in a most downstream position, along a conveyance direction of the developer, in developer supply path 812. Stirring screw 82 includes shaft 821, and spiral blade 822 formed over substantially the whole length of the shaft at a prescribed pitch, and supply screw 83 includes, similarly to stirring screw 82, shaft 831, and spiral blade 832 formed over substantially the whole length of the shaft at a prescribed pitch.

Toner supply section 89 is disposed above developer container 81. Toner supply section 89 has tonner supply port 81a capable of connecting/disconnecting toner supply section 89 and developer container 81 to/from each other, and a hopper not illustrated containing the toner and connected to toner supply port 81a. To toner supply section 89, tonner bottle 91 that supplies the toner particle to the hopper is connected rotatably around the central axis thereof. Toner bottle 91 is connected to toner supply section 89 with the axial direction thereof set to be substantially horizontal.

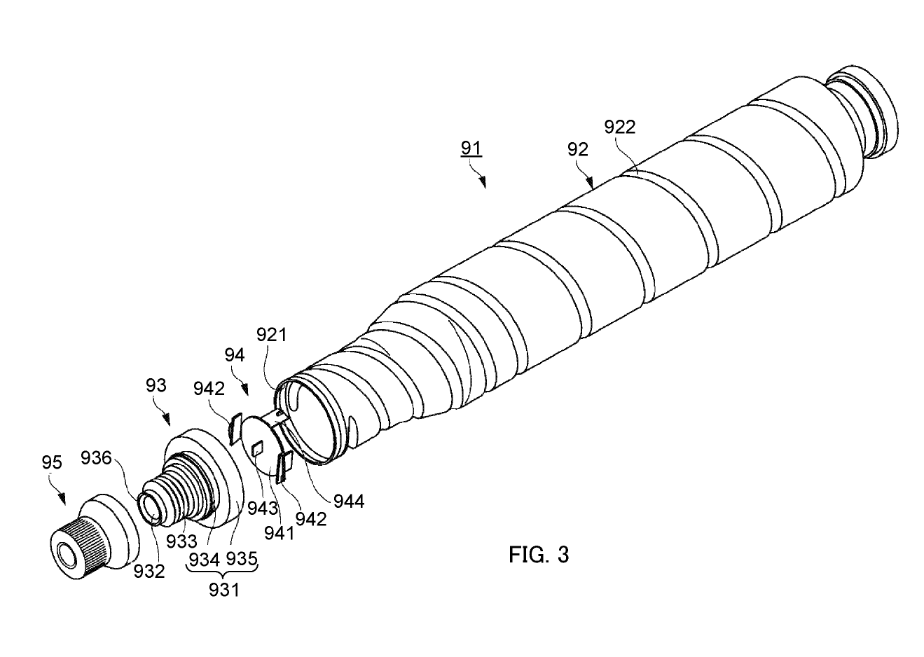

Toner bottle 91 is made of, for example, a resin, and includes, as illustrated in FIG. 3, container main body 92, discharge member 93 disposed in a tip portion of container main body 92, and restriction member 94 disposed inside container main body 92 and discharge member 93. Toner bottle 91 contains the above-described toner particle.

Container main body 92 is in a substantially cylindrical hollow shape, and has opening 921 on a tip side. On a sidewall of container main body 92, ridge portion 922 projecting inward from the sidewall is formed. Ridge portion 922 is formed spirally from a rear end portion to the tip portion of container main body 92. It is noted that the spiral direction of ridge portion 922 is set in accordance with the rotational direction of container main body 92.

Discharge member 93 is attached to container main body 92 to close opening 921. Discharge member 93 includes mouth portion 931, discharging portion 932 and covering portion 933.

Mouth portion 931 is in a cylindrical shape, and has thread portion 934 on a tip side and catch portion 935 on a rear side. Thread portion 934 is screwed into a thread groove provided in the inside of cap 95. Catch portion 935 catches the tip portion of container main body 92.

Discharging portion 932 has engaging portion 936. Engaging portion 936 holds covering portion 933 covering the circumference of discharging portion 932. Covering portion 933 is a substantially cylindrical stretchable bellow-like member, and has a base fixed on a tip of mouth portion 931 and a tip held by engaging portion 936. When toner bottle 91 is inserted into toner supply section 89 to be loaded, covering portion 933 contracts to cause a supply port not illustrated to appear, and toner bottle 91 is connected to toner supply section 89.

Restriction member 94 includes partition portion 941, and further includes, on a tip side of partition portion 941, a pair of engaging portions 942 projecting from edges of partition portion 941, and knob portion 943 projecting from a center part of partition portion 941, and on a rear side of partition portion 941, a pair of leg portions 944 projecting from edges of partition portion 941. Partition portion 941 is in a circular plate shape, and has a diameter smaller than the diameter of opening 921. The pair of engaging portions 942 are engaged with an end, closer to opening 921, of ridge portion 922 inside container main body 92, so that restriction member 94 can be disposed within container main body 92 in the vicinity of opening 921 of container main body 92.

Intermediate transfer unit 42 includes intermediate transfer belt 421, primary transfer roller 422 pressing intermediate transfer belt 421 against each photoconductor drum 413, plural support rollers 423 including backup roller 423A, and belt cleaning device 426. Intermediate transfer belt 421 is extended, in a loop shape, among plural support rollers 423. When at least one drive roller out of plural support rollers 423 rotates, intermediate transfer belt 421 runs at a constant speed in a direction of arrow A.

Secondary transfer unit 43 includes endless secondary transfer belt 432, and plural support rollers 431 including secondary transfer roller 431A. Secondary transfer belt 432 is extended, in a loop shape, among secondary transfer roller 431A and support rollers 431.

Fixing device 60 includes, for example, fixing roller 62, endless heating belt 10 covering an outer peripheral surface of fixing roller 62 and heating and melting a toner forming a toner image on sheet S, and pressure roller 63 pressing sheet S against fixing roller 62 and heating belt 10. Sheet S corresponds to a recording medium.

Image forming apparatus 100 further includes image reading section 110, image processing section 30 and sheet conveying section 50 as described above. Image reading section 110 includes sheet feeding device 111 and scanner 112. Sheet conveying section 50 includes sheet feed section 51, sheet ejection section 52 and conveyance path section 53. In three sheet feed tray units 51a to 51c included in sheet feed section 51, sheets S (including standard sheets and special sheets) identified based on weight or size are contained separately in accordance with types of sheets precedently set. Conveyance path section 53 includes a plurality of conveyance roller pairs such as registration roller pair 53a.

The black toner, the yellow toner, the magenta toner and the cyan toner are available as a set (toner set) of toner bottles respectively containing these toners, and supplied to developing devices 412 by attaching the toner bottles to the corresponding developing devices. Each of developing devices 412 of the respective colors contains the toner of the corresponding color, and these toners constitute the toner set even in a state where they are supplied to developing devices 412.

Image formation performed by image forming apparatus 100 will now be described.

Scanner 112 optically scans and reads original D placed on a contact glass. Reflected light from original D is read by CCD sensor 112a to obtain input image data. The input image data is subjected to prescribed image processing in image processing section 30, and the resultant is transferred to exposing device 411.

Each photoconductor drum 413 rotates at a constant peripheral speed. Charging device 414 evenly negatively charges the surface of photoconductor drum 413. In exposing device 411, a polygon mirror of the polygon motor rotates at a high speed, laser beams in accordance with respective color components of the input image data are developed along the axial direction of photoconductor drum 413, so as to irradiate the outer peripheral surface of photoconductor drum 413 along the axial direction. In this manner, an electrostatic image is formed on the surface of photoconductor drum 413.

In developing device 412, the toner particle is charged by stirring and conveying the two-component developer in the developer container, and the resultant two-component developer is conveyed to the developing roller, and forms a magnetic brush on the surface of the developing roller. The charged toner particle electrostatically adheres, from the magnetic brush, onto a portion of photoconductor drum 413 corresponding to the electrostatic latent image. In this manner, the electrostatic latent image on the surface of photoconductor drum 413 is visualized, and a toner image corresponding to the electrostatic latent image is formed on the surface of photoconductor drum 413.

The amount of the toner particle contained in developer container 81 is detected by toner density sensor 86. If the amount of the toner particle becomes small, toner bottle 91 is rotatively driven in accordance with a detection signal of toner density sensor 86. Thus, restriction member 94 is rotatively driven together with toner bottle 91, and the toner particle contained in toner bottle 91 is conveyed to discharging portion 932 through a gap between restriction member 94 and toner bottle 91, and contained in the hopper of toner supply section 89. When a necessary amount of the toner particle is contained in the hopper, the rotational drive of toner bottle 91 is stopped, and hence the supply of the toner particle to the hopper is stopped. Then, toner supply port 81a is opened, the toner particle contained in the hopper is supplied into developer container 81, and thus, the toner particle is replenished to developer container 81.

If any of the black toner, the yellow toner, the magenta toner and the cyan toner runs short, an instruction to replenish the toner of any of the colors is displayed in image forming apparatus 100, and thereafter, a toner bottle containing the corresponding toner is supplied. Thus, even if a part of the toner set has been consumed, the same type of toner is replenished to be supplied to developing device 412, and the toner set is continuously constituted in image forming apparatus 100.

The toner image formed on the surface of photoconductor drum 413 is transferred onto intermediate transfer belt 421 by intermediate transfer unit 42. A portion of the toner remaining on the surface of photoconductor drum 413 after the transfer is removed by cleaning device 415 having a cleaning blade brought into sliding contact with the surface of photoconductor drum 413.

Since intermediate transfer belt 421 is pressed against photoconductor drum 413 by primary transfer roller 422, a primary transfer nip is formed on each photoconductor drum by photoconductor drum 413 and intermediate transfer belt 421. In these primary transfer nips, toner images of the respective colors are successively transferred to be superimposed on intermediate transfer belt 421.

Secondary transfer roller 431A is pressed against backup roller 423A via intermediate transfer belt 421 and secondary transfer belt 432. Therefore, a secondary transfer nip is formed by intermediate transfer belt 421 and secondary transfer belt 432. Sheet S is conveyed by sheet conveying section 50 to the secondary transfer nip, and passes through the secondary transfer nip. A registration roller section including registration roller pair 53a corrects inclination of sheet S and adjusts conveying timing of sheet S.

In color image formation, image noise such as unevenness in image density may be generally caused in a formed image in some cases. This is probably for the following reason: A colorant of a black toner generally has conductivity, and if a base particle of the black toner contains a crystalline polyester resin, a conductive path is formed between the black colorant and a domain of the crystalline polyester resin. Therefore, in transferring the black toner, charge may be leaked to degrade transferability. As a result, the black toner cannot attain transferability equivalent to that of a chromatic color toner.

The toners of the respective colors contained in the toner set, however, satisfy the relationships represented by expressions 1-1 to 1-3 described above. Therefore, the colorant is better dispersed in the black toner than in the chromatic color toners, and hence, the black toner attains charge stability equivalent to that of the chromatic color toners. As a result, the toners of the respective colors have equivalent transferability, and hence, the occurrence of image noise such as unevenness in image density otherwise caused by uneven transferability can be inhibited.

When sheet S is conveyed to the secondary transfer nip, a transfer bias is applied to secondary transfer roller 431A. Through the application of the transfer bias, the toner image born on intermediate transfer belt 421 is transferred onto sheet S. Sheet S having the toner image transferred thereon is conveyed toward fixing device 60 by secondary transfer belt 432.

Fixing device 60 forms a fixing nip between heating belt 10 and pressure roller 63, so as to heat and press conveyed sheet S in the fixing nip. The toner particle contained in the toner image born on sheet S is heated, and hence the crystalline resin is rapidly melted therein, and as a result, the whole toner particle rapidly melts with a comparatively small amount of heat. Therefore, the toner component adheres to sheet S, and is rapidly crystallized thereon and rapidly solidified. Thus, the toner image is rapidly fixed on sheet S with a comparatively small amount of heat. Sheet S having the toner image fixed thereon is ejected out of the apparatus by sheet ejection section 52 including sheet ejection roller 52a. In this manner, a high quality image is formed.

Incidentally, a portion of the toner remaining on the surface of intermediate transfer belt 421 after the secondary transfer is removed by belt cleaning device 426 having a belt cleaning blade brought into sliding contact with the surface of intermediate transfer belt 421.

As is obvious from the description given so far, each toner of the toner set contains an amorphous resin, a crystalline resin and a colorant, the colorant of the black toner contains a conductive black colorant, and the exothermic peak temperatures rc(Y), rc(M), rc(C) and rc(K) of the yellow toner, the magenta toner, the cyan toner and the black toner obtained in temperature decrease in differential scanning calorimetry satisfy the following expressions 1-1 to 1-3. Accordingly, in the electrophotographic image forming method using toners each containing a crystalline resin, the low-temperature fixability and the transferability can be both attained.

0.5≦rc(Y)−rc(K)≦10 Expression 1-1:

0.5≦rc(M)−rc(K)≦10 Expression 1-2:

0.5≦rc(C)−rc(K)≦10 Expression 1-3:

Besides, it is more effective from the viewpoint of further improving both the transferability and the low-temperature fixability if the exothermic peak temperatures satisfy the following expressions 2-1 to 2-3, and it is further more effective from the same viewpoint if the exothermic peak temperatures satisfy the following expressions 3-1 to 3-3:

1.5≦rc(Y)−rc(K)≦8 Expression 2-1:

1.5≦rc(M)−rc(K)≦8 Expression 2-2:

1.5≦rc(C)−rc(K)≦8 Expression 2-3:

3≦rc(Y)−rc(K)≦6 Expression 3-1:

3≦rc(M)−rc(K)≦6 Expression 3-2:

3≦rc(C)−rc(K)≦6 Expression 3-3:

It is further more effective from the viewpoint of easily realizing good relationships in chargeability among the toners of the respective colors if the toners of the respective colors contain the same crystalline resin.

Besides, it is further more effective from the viewpoint of improving the low-temperature fixability of the toner if the crystalline resin is crystalline polyester.

It is further more effective from the viewpoint of attaining both the low-temperature fixability and the transferability under a high-temperature and high-humidity environment if the content of the crystalline resin in the toner of each color is 5 to 20 mass %.

Besides, it is further more effective from the viewpoint of attaining both the low-temperature fixability and the high-temperature storage stability if the exothermic peak temperatures of the toners of the respective colors are 45 to 75° C.

In this manner, according to the image forming method of the present embodiment, even if a toner containing a crystalline resin is used, the low-temperature fixability and the transferability can be both attained.

### EXAMPLES

The present invention will now be more specifically described with reference to examples and comparative examples. It is noted that the present invention is not limited to the following examples and the like. In the following examples, the terms “part(s)” and “%” respectively mean “part(s) by mass” and “mass %” unless otherwise specified.

[Preparation of Amorphous Resin Fine Particle Dispersion (Amorphous Dispersion) X1]

(1) First Stage Polymerization

A 5 L reaction vessel equipped with a stirring device, a temperature sensor, a condenser and a nitrogen introducing device was charged with 8 parts by mass of sodium dodecyl sulfate and 3,000 parts by mass of ion-exchanged water, and the internal temperature of the reaction vessel was increased to 80° C. in a nitrogen stream under stirring at a stirring rate of 230 rpm. After the temperature increase, to the resultant mixed solution, an aqueous solution obtained by dissolving 10 parts by mass of potassium persulfate in 200 parts by mass of ion-exchanged water was added, and the temperature of the thus obtained mixed solution was increased to 80° C. again. To the mixed solution, monomer mixed solution 1 having the following composition was added in a dropwise manner over 1 hour, the resultant mixed solution was heated and stirred for 2 hours at 80° C. for performing polymerization, and thus, resin fine particle dispersion x1 was prepared.

| | | |
|---|---|---|
| Styrene | 480 | parts by mass |
| n-Butyl acrylate | 250 | parts by mass |
| Methacrylic acid | 68 | parts by mass |

(2) Second Stage Polymerization

A 5 L reaction vessel equipped with a stirring device, a temperature sensor, a condenser and a nitrogen introducing device was charged with a solution obtained by dissolving 7 parts by mass of sodium polyoxyethylene (2) dodecyl ether sulfate in 3,000 parts by mass of ion-exchanged water, and the thus obtained solution was heated to 80° C. To the resulting solution, 80 parts by mass of resin fine particle dispersion x1 (in terms of a solid component) and monomer mixed solution 2 obtained by dissolving monomers and release agents listed below at 90° C. were added, and the resultant was mixed and dispersed for 1 hour using a mechanical disperser having a circulating path, “CLEARMIX” (manufactured by M Technique Co., Ltd., “CLEARMIX” being their registered trademark) to prepare a dispersion containing an emulsion particle (an oil droplet). The behenyl behenate listed below is a release agent having a melting point of 73° C.

| | | |
|---|---|---|
| Styrene | 285 | parts by mass |
| n-Butyl acrylate | 95 | parts by mass |
| Methacrylic acid | 20 | parts by mass |
| n-Octyl 3-mercaptopropionate | 8 | parts by mass |
| Behenyl behenate | 190 | parts by mass |

Subsequently, an initiator solution obtained by dissolving 6 parts by mass of potassium persulfate in 200 parts by mass of ion-exchanged water was added to the dispersion, the resultant dispersion was heated and stirred at 84° C. for 1 hour for performing polymerization, and thus, resin fine particle dispersion x2 was prepared.

(3) Third Stage Polymerization

Thereafter, 400 parts by mass of ion-exchanged water was added to resin fine particle dispersion x2, followed by sufficiently mixing. To the resultant dispersion, a solution obtained by dissolving 11 parts by mass of potassium persulfate in 400 parts by mass of ion-exchanged water was added, and then, monomer mixed solution 3 having the following composition was added thereto in a dropwise manner at 82° C. over 1 hour. After completing the dropwise addition, the resultant dispersion was heated and stirred for 2 hours for performing polymerization, and then cooled to 28° C., and thus, amorphous resin fine particle dispersion (sometimes referred to as “amorphous dispersion”) X1 containing a vinyl resin (styrene-acrylic resin) was prepared.

| | | |
|---|---|---|
| Styrene | 307 | parts by mass |
| n-Butyl acrylate | 147 | parts by mass |
| Methacrylic acid | 52 | parts by mass |
| n-Octyl 3-mercaptopropionate | 8 | parts by mass |

Physical properties of the thus obtained amorphous dispersion X1 were measured to find that the median diameter D50v based on the volume of the amorphous resin fine particle was 220 nm, that the glass transition temperature Tg was 46° C., and that the weight average molecular weight Mw was 32,000.

[Preparation of Amorphous Dispersions X2 to X8]

Amorphous resin fine particle dispersions (amorphous dispersions) X2 to X8 were obtained in the same manner as in the preparation of amorphous dispersion X1 except that the amount of n-octyl 3-mercaptopropionate used in the third stage polymerization was changed respectively to 12 parts by mass, 18 parts by mass, 4 parts by mass, 14 parts by mass, 6 parts by mass, 16 parts by mass and 10 parts by mass. In amorphous dispersion X2, the median diameter D50v of the amorphous fine resin particle was 225 nm, the glass transition temperature Tg was 45° C., and the weight average molecular weight Mw was 24,000. In amorphous dispersion X3, the median diameter D50v of the amorphous fine resin particle was 235 nm, the glass transition temperature Tg was 42° C., and the weight average molecular weight Mw was 12,000. In amorphous dispersion X4, the median diameter D50v of the amorphous fine resin particle was 210 nm, the glass transition temperature Tg was 46° C., and the weight average molecular weight Mw was 40,000. In amorphous dispersion X5, the median diameter D50v of the amorphous fine resin particle was 220 nm, the glass transition temperature Tg was 44° C., and the weight average molecular weight Mw was 20,000. In amorphous dispersion X6, the median diameter D50v of the amorphous fine resin particle was 210 nm, the glass transition temperature Tg was 46° C., and the weight average molecular weight Mw was 36,000. In amorphous dispersion X7, the median diameter D50v of the amorphous fine resin particle was 230 nm, the glass transition temperature Tg was 43° C., and the weight average molecular weight Mw was 16,000. In amorphous dispersion X8, the median diameter D50v of the amorphous fine resin particle was 220 nm, the glass transition temperature Tg was 45° C., and the weight average molecular weight Mw was 28,000.

[Preparation of Amorphous Dispersion X9]

Amorphous resin fine particle dispersion (amorphous dispersion) X9 was obtained in the same manner as in the preparation of amorphous dispersion X1 except that monomer mixed solution 2 was replaced with the following monomer mixed solution 2-9 in the second stage polymerization and that monomer mixed solution 3 was replaced with the following monomer mixed solution 3-9 in the third stage polymerization. In amorphous dispersion X9, the median diameter D50v of the amorphous fine resin particle was 210 nm, the glass transition temperature Tg was 46° C., and the weight average molecular weight Mw was 32,000.

(Monomer mixed solution 2-9)

| | | |
|---|---|---|
| Styrene | 299 | parts by mass |
| n-Butyl acrylate | 100 | parts by mass |
| Methacrylic acid | 21 | parts by mass |
| n-Octyl 3-mercaptopropionate | 8 | parts by mass |
| Behenyl behenate | 132 | parts by mass |

(Monomer mixed solution 3-9)

| | | |
|---|---|---|
| Styrene | 323 | parts by mass |
| n-Butyl acrylate | 154 | parts by mass |
| Methacrylic acid | 52 | parts by mass |
| n-Octyl 3-mercaptopropionate | 8 | parts by mass |

[Preparation of Amorphous Dispersion X10]

Amorphous resin fine particle dispersion (amorphous dispersion) X10 was obtained in the same manner as in the preparation of amorphous dispersion X1 except that monomer mixed solution 2 was replaced with the following monomer mixed solution 2-10 in the second stage polymerization and that monomer mixed solution 3 was replaced with the following monomer mixed solution 3-10 in the third stage polymerization. In amorphous dispersion X10, the median diameter D50v of the amorphous fine resin particle was 220 nm, the glass transition temperature Tg was 46° C., and the weight average molecular weight Mw was 32,000.

(Monomer mixed solution 2-10)

| | | |
|---|---|---|
| Styrene | 279 | parts by mass |
| n-Butyl acrylate | 93 | parts by mass |
| Methacrylic acid | 20 | parts by mass |
| n-Octyl 3-mercaptopropionate | 8 | parts by mass |
| Behenyl behenate | 211 | parts by mass |

(Monomer mixed solution 3-10)

| | | |
|---|---|---|
| Styrene | 302 | parts by mass |
| n-Butyl acrylate | 144 | parts by mass |
| Methacrylic acid | 51 | parts by mass |
| n-Octyl 3-mercaptopropionate | 8 | parts by mass |

[Preparation of Amorphous Dispersion X11]

Amorphous resin fine particle dispersion (amorphous dispersion) X11 was obtained in the same manner as in the preparation of amorphous dispersion X10 except that the amount of n-octyl 3-mercaptopropionate used in monomer mixed solution 3-10 was changed to 12 parts by mass. In amorphous dispersion X11, the median diameter D50v of the amorphous fine resin particle was 220 nm, the glass transition temperature Tg was 45° C., and the weight average molecular weight Mw was 24,000.

[Preparation of Amorphous Dispersion X12]

Amorphous resin fine particle dispersion (amorphous dispersion) X12 was obtained in the same manner as in the preparation of amorphous dispersion X9 except that the amount of n-octyl 3-mercaptopropionate used in monomer mixed solution 3-9 was changed to 18 parts by mass. In amorphous dispersion X12, the median diameter D50v of the amorphous fine resin particle was 225 nm, the glass transition temperature Tg was 41° C., and the weight average molecular weight Mw was 12,000.

The main compositions and physical properties of amorphous dispersions X1 to X12 are shown in Table 1. In Table 1, “OMP” stands for n-octyl 3-mercaptopropionate, and “A-Dis” stands for “amorphous dispersion”.

TABLE 1

| A-Dis | OMP | Release Agent | D50v | Tg | Mw |
|---|---|---|---|---|---|
| No. | [parts by mass] | [parts by mass] | [nm] | [° C.] | [—] |
| X1 | 8 | 190 | 220 | 46 | 32000 |
| X2 | 12 | 190 | 225 | 45 | 24000 |
| X3 | 18 | 190 | 235 | 42 | 12000 |
| X4 | 4 | 190 | 210 | 46 | 40000 |
| X5 | 14 | 190 | 220 | 44 | 20000 |
| X6 | 6 | 190 | 210 | 46 | 36000 |
| X7 | 16 | 190 | 230 | 43 | 16000 |
| X8 | 10 | 190 | 220 | 45 | 28000 |
| X9 | 8 | 132 | 210 | 46 | 32000 |
| X10 | 8 | 211 | 220 | 46 | 32000 |
| X11 | 12 | 211 | 220 | 45 | 24000 |
| X12 | 18 | 132 | 225 | 41 | 12000 |

[Synthesis of Crystalline Polyester Resin 1]

A reaction vessel equipped with a stirrer, a thermometer, a condenser and a nitrogen gas introducing tube was charged with 281 parts by mass of dodecanedioic acid and 283 parts by mass of 1,6-hexanediol. After the reaction vessel atmosphere was replaced with a dry nitrogen gas, 0.1 parts by mass of Ti(OBu)₄ was added thereto, and the thus obtained mixed solution was stirred at about 180° C. for 8 hours in a nitrogen gas stream for performing a reaction. To the resultant mixed solution, 0.2 parts by mass of Ti(OBu)₄ was further added, and the temperature of the resultant mixed solution was increased to about 220° C., and was stirred for 6 hours to perform a reaction. Thereafter, the pressure within the reaction vessel was reduced to 1333.2 Pa, and a reaction was performed under reduced pressure to obtain crystalline polyester resin 1. Crystalline polyester resin 1 had a number average molecular weight Mn of 5,500, a weight average molecular weight Mw of 18,000, and a melting point Tm of 67° C.

[Synthesis of Crystalline Polyester Resin 2]

Crystalline polyester resin 2 was obtained in the same manner as in the synthesis of crystalline polyester resin 1 except that dodecanedioic acid was replaced with sebacic acid. Crystalline polyester resin 2 had a number average molecular weight Mn of 5,000, a weight average molecular weight Mw of 19,000 and a melting point Tm of 62° C.

[Synthesis of Crystalline Polyester Resin 3]

Crystalline polyester resin 3 was obtained in the same manner as in the synthesis of crystalline polyester resin 1 except that 1,6-hexanediol was replaced with 1,12-dodecanediol. Crystalline polyester resin 3 had a number average molecular weight Mn of 5,600, a weight average molecular weight Mw of 19,000 and a melting point Tm of 78° C.

[Preparation of Crystalline Resin Fine Particle Dispersion (Crystalline Dispersion) C1]

Thirty (30) parts by mass of crystalline polyester resin 1 in a melted state was transferred to an emulsion disperser “Cavitron CD1010” (manufactured by Eurotec Co., Ltd.) at a transfer rate of 100 parts by mass per min. At the same time, 0.37 mass % dilute ammonia water was transferred to the emulsion disperser at a transfer rate of 0.1 liter per min while heating to 100° C. with a heat exchanger. The dilute ammonia water was prepared by diluting 70 parts by mass of reagent ammonia water with ion-exchanged water in an aqueous solvent tank.

Then, the emulsion disperser was operated at a rotational speed of a rotor of 60 Hz and a pressure of 5 kg/cm² (490 kPa) to prepare crystalline resin fine particle dispersion (crystalline dispersion) C1 of crystalline polyester resin 1 having a solid content of 30 parts by mass. The median diameter D50v based on the volume of a particle of crystalline polyester resin 1 contained in crystalline dispersion C1 was 200 nm.

[Preparation of Crystalline Dispersion C2]

Crystalline resin fine particle dispersion (crystalline dispersion) C2 was prepared in the same manner as in the preparation of crystalline dispersion 1 except that crystalline polyester resin 1 was replaced with crystalline polyester resin 2. The median diameter D50v of a particle of crystalline polyester resin 2 contained in crystalline dispersion C2 was 230 nm.

[Preparation of Crystalline Dispersion C3]

Crystalline resin fine particle dispersion (crystalline dispersion) C3 was prepared in the same manner as in the preparation of crystalline dispersion 1 except that crystalline polyester resin 1 was replaced with crystalline polyester resin 3. The median diameter D50v of a particle of crystalline polyester resin 3 contained in crystalline dispersion C3 was 185 nm.

[Preparation of Colorant Fine Particle Dispersion (Colorant Dispersion) Bk]

Ninety (90) parts by mass of sodium dodecyl sulfate was dissolved in 1,600 parts by mass of ion-exchanged water with stirring, and to the resultant solution, 420 parts by mass of carbon black “Regal 330R” (manufactured by Cabot Corporation) was slowly added under stirring. The thus obtained dispersion was dispersed using a stirring apparatus “CLEARMIX” (manufactured by M Technique Co., Ltd.) to prepare colorant fine particle dispersion (colorant dispersion) Bk in which a fine particle of the colorant was dispersed. The median diameter D50v based on the volume of the particle contained in colorant dispersion Bk measured with a microtrack particle size distribution analyzer “UPA-150” (manufactured by MicrotracBEL Corp.) was 120 nm.

[Preparation of Colorant Dispersion Y]

Colorant fine particle dispersion (colorant dispersion) Y was prepared in the same manner as in the preparation of colorant dispersion Bk except that carbon black was replaced with C.I. pigment yellow 74. The median diameter D50v based on the volume of the particle contained in colorant dispersion Y was 170 nm.

[Preparation of Colorant Dispersion M]

Colorant fine particle dispersion (colorant dispersion) M was prepared in the same manner as in the preparation of colorant dispersion Bk except that carbon black was replaced with C.I. pigment red 122. The median diameter D50v based on the volume of the particle contained in colorant dispersion M was 183 nm.

[Preparation of Colorant Dispersion C]

Colorant fine particle dispersion (colorant dispersion) C was prepared in the same manner as in the preparation of colorant dispersion Bk except that carbon black was replaced with C.I. pigment blue 18:3. The median diameter D50v based on the volume of the particle contained in colorant dispersion C was 161 nm.

[Synthesis of Shell Amorphous Resin]

Monomer mixed solution 4 containing an amphoteric monomer (acrylic acid) and containing the following components in the following contents was put in a dropping funnel. Here, di-t-butyl peroxide was used as a polymerization initiator.

| | |
|---|---|
| Styrene | 80 parts by mass |
| n-Butyl acrylate | 20 parts by mass |
| Acrylic acid | 10 parts by mass |
| Di-t-butyl peroxide | 16 parts by mass |

The following material monomers of a resin (amorphous polyester resin) unit for a polycondensation system were put in a four-necked flask equipped with a nitrogen introducing tube, a dehydration tube, a stirrer and a thermocouple, and heated to 170° C. to be dissolved.

| | | |
|---|---|---|
| Bisphenol A propylene oxide 2-mol adduct | 285.7 | parts by mass |
| Terephthalic acid | 66.9 | parts by mass |
| Fumaric acid | 47.4 | parts by mass |

To the thus obtained solution, monomer mixed solution 4 was added in a dropwise manner over 90 minutes under stirring, the resultant was aged for 60 minutes, and an unreacted portion of the monomers of monomer mixed solution 4 was removed from the four-necked flask under reduced pressure (8 kPa).

Thereafter, 0.4 parts by mass of Ti(OBu)₄ was added as an esterification catalyst into the four-necked flask, the resultant mixed solution in the four-necked flask was heated to 235° C. to perform a reaction under normal pressure (101.3 kPa) for 5 hours and under reduced pressure (8 kPa) for 1 hour.

After cooling the mixed solution to 200° C., the mixed solution was reacted under reduced pressure (20 kPa) until a reaction product attained a desired softening point. Subsequently, the solvent was removed to obtain shell amorphous resin s1. The thus obtained shell amorphous resin s1 had a glass transition temperature Tg of 60° C., and a weight average molecular weight Mw of 30,000.

[Preparation of Shell Resin Fine Particle Dispersion (Shell Dispersion) S1]

One hundred (100) parts by mass of shell amorphous resin s1 was dissolved in 400 parts by mass of ethyl acetate (manufactured by Kanto Kagaku K.K.), and mixed with 638 parts by mass of a precedently prepared 0.26 mass % sodium lauryl sulfate solution. The thus obtained mixed solution was subjected to ultrasonic dispersion under stirring by using an ultrasonic homogenizer “US-150T” (manufactured by Nihonseiki Kaisha Ltd.) at V-Level of 300 μA for 30 minutes. Thereafter, with the mixed solution heated to 40° C., the mixed solution was stirred under reduced pressure for 3 hours using a diaphragm vacuum pump “V-700” (manufactured by BUCHI) to completely remove ethyl acetate. In this manner, shell amorphous resin fine particle dispersion (shell dispersion) S1 having a solid content of 13.5 mass % was prepared. The median diameter D50v based on the volume of the shell resin particle contained in shell dispersion S1 was 160 nm.

[Production of Black Toner Bk-1]

A reaction vessel equipped with a stirring device, a temperature sensor and a condenser was charged with 288 parts by mass of amorphous dispersion X1 (in terms of a solid content) and 2,000 parts by mass of ion-exchanged water, and a 5 mol/L sodium hydroxide aqueous solution was further added thereto to adjust pH of the resultant dispersion contained in the reaction vessel to 10 (at a measurement temperature of 25° C.).

To the dispersion, 30 parts by mass of color dispersion Bk (in terms of a solid content) was added. Subsequently, an aqueous solution obtained by dissolving 30 parts by mass of magnesium chloride used as a coagulant in 60 parts by mass of ion-exchanged water was added to the dispersion at 30° C. over 10 minutes under stirring. The thus obtained mixed solution was heated to 80° C., and 40 parts by mass of crystalline dispersion C1 (in terms of a solid content) was added thereto over 10 minutes to cause agglomeration to proceed.

The particle size of a combined particle contained in the mixed solution was measured with “Coulter Multisizer 3” (manufactured by Beckman Coulter Ind.), and when the median diameter D50v based on the volume of the particle reached 6.0 μm, 37 parts by mass of shell dispersion S1 (in terms of a solid content) was added to the mixed solution over 30 minutes. When a supernatant of the thus obtained reaction solution became transparent, an aqueous solution obtained by dissolving 190 parts by mass of sodium chloride in 760 parts by mass ion-exchanged water was added to the reaction solution to stop the growth of the particle.

The reaction solution was heated to 80° C. and stirred to fuse the particle, and the particle contained in the reaction solution was measured using a measurement apparatus “FPIA-2100” (manufactured by Sysmex Corporation) (with HPF detection number set to 4,000). When the particle attained an average circularity of 0.945, the reaction solution was cooled to 30° C. at a cooling rate of 2.5° C./min.

Subsequently, the particle was separated from the cooled reaction solution and dehydrated, and the thus obtained cake was washed by repeating, three times, redispersion in ion-exchanged water and solid-liquid separation. The resultant was dried at 40° C. for 24 hours to obtain black toner base particle Bk-1.

To 100 parts by mass of black toner base particle Bk-1, 0.6 parts by mass of hydrophobic silica (having a number average primary particle size of 12 nm and hydrophobicity of 68) and 1.0 part by mass of hydrophobic titanium oxide (having a number average primary particle size of 20 nm and hydrophobicity of 63) were added. The resultant was mixed using “Henschel mixer” (Nippon Coke & Engineering Co., Ltd.) at a blade-tip peripheral speed of 35 mm/sec and 32° C. for 20 minutes, and the resultant was sieved with a sieve having an opening of 45 μm to remove a coarse particle. Through such an external additive treatment, black toner particle Bk-1 for use in electrostatic image development was produced.

Black toner particle Bk-1 and a ferrite carrier coated with an acrylic resin and having a volume average particle size of 32 μm were mixed to attain a toner particle concentration of 6 mass %. Thus, a two-component developer, black toner Bk-1, was produced.

[Production of Black Toners Bk-2 to Bk-7, Bk-10 and Bk-11]

Black toners Bk-2 to Bk-7, Bk-10 and Bk-11 were produced in the same manner as in the production of black toner Bk-1 except that amorphous dispersion X1 was respectively replaced with amorphous dispersions X3 to X6 and X9 to X12.

[Production of Black Toners Bk-8 and Bk-9]

Black toner Bk-8 was produced in the same manner as in the production of black toner Bk-1 except that crystalline dispersion C1 was replaced with crystalline dispersion C2. Black toner Bk-9 was produced in the same manner as in the production of black toner Bk-1 except that crystalline dispersion C1 was replaced with crystalline dispersion C3.

[Production of Yellow Toners Y-1 to Y-5]

Yellow toner Y-1 was produced in the same manner as in the production of black toner Bk-1 except that amorphous dispersion X1 was replaced with amorphous dispersion X2 and that colorant dispersion Bk was replaced with colorant dispersion Y

Yellow toner Y-2 was produced in the same manner as in the production of yellow toner Y-1 except that amorphous dispersion X2 was replaced with amorphous dispersion X7. Yellow toner Y-3 was produced in the same manner as in the production of yellow toner Y-1 except that amorphous dispersion X2 was replaced with amorphous dispersion X8.

Yellow toner Y-4 was produced in the same manner as in the production of yellow toner Y-1 except that crystalline dispersion C1 was replaced with crystalline dispersion C2. Yellow toner Y-5 was produced in the same manner as in the production of yellow toner Y-1 except that crystalline dispersion C1 was replaced with crystalline dispersion C3.

[Production of Magenta Toners M-1 to M-5]

Magenta toner M-1 was produced in the same manner as in the production of black toner Bk-1 except that amorphous dispersion X1 was replaced with amorphous dispersion X2 and that colorant dispersion Bk was replaced with colorant dispersion M.

Magenta toner M-2 was produced in the same manner as in the production of magenta toner M-1 except that amorphous dispersion X2 was replaced with amorphous dispersion X7. Magenta toner M-3 was produced in the same manner as in the production of magenta toner M-1 except that amorphous dispersion X2 was replaced with amorphous dispersion X8.

Magenta toner M-4 was produced in the same manner as in the production of magenta toner M-1 except that crystalline dispersion C1 was replaced with crystalline dispersion C2. Magenta toner M-5 was produced in the same manner as in the production of magenta toner M-1 except that crystalline dispersion C1 was replaced with crystalline dispersion C3.

[Production of Cyan Toners C-1 to C-5]

Cyan toner C-1 was produced in the same manner as in the production of black toner Bk-1 except that amorphous dispersion X1 was replaced with amorphous dispersion X2 and that colorant dispersion Bk was replaced with colorant dispersion C.

Cyan toner C-2 was produced in the same manner as in the production of cyan toner C-1 except that amorphous dispersion X2 was replaced with amorphous dispersion X7. Cyan toner C-3 was produced in the same manner as in the production of cyan toner C-1 except that amorphous dispersion X2 was replaced with amorphous dispersion X8.

Cyan toner C-4 was produced in the same manner as in the production of cyan toner C-1 except that crystalline dispersion C1 was replaced with crystalline dispersion C2. Cyan toner C-5 was produced in the same manner as in the production of cyan toner C-1 except that crystalline dispersion C1 was replaced with crystalline dispersion C3.

Black toners Bk-1 to Bk-11, yellow toners Y-1 to Y-5, magenta toners M-1 to M-5 and cyan toners C-1 to C-5 were combined to obtain toner sets of respective Examples as shown in Table 2. The combination of the toners of the respective colors in each toner set and the combination of the amorphous dispersion and the crystalline dispersion employed in the production of the toner of each color are shown in Table 2. In Table 2, “A-Dis” stands for “amorphous dispersion”, and “C-Dis” stands for “crystalline dispersion”.

TABLE 2

| | Black Toner | | | Yellow Toner | | | Magenta Toner | | | Cyan Toner | | |
|---|---|---|---|---|---|---|---|---|---|---|---|---|
| | Toner | A-Dis | | Toner | A-Dis | | Toner | | | Toner | | |
| | No. | No. | C-Dis No. | No. | No. | C-Dis No. | No. | A-Dis No. | C-Dis No. | No. | A-Dis No. | C-Dis No. |
| Example 1 | Bk-1 | X1 | C1 | Y-1 | X2 | C1 | M-1 | X2 | C1 | C-1 | X2 | C1 |
| Example 2 | Bk-2 | X3 | C1 | Y-1 | X2 | C1 | M-1 | X2 | C1 | C-1 | X2 | C1 |
| Example 3 | Bk-3 | X4 | C1 | Y-1 | X2 | C1 | M-1 | X2 | C1 | C-1 | X2 | C1 |
| Example 4 | Bk-4 | X5 | C1 | Y-1 | X2 | C1 | M-1 | X2 | C1 | C-1 | X2 | C1 |
| Example 5 | Bk-5 | X6 | C1 | Y-1 | X2 | C1 | M-1 | X2 | C1 | C-1 | X2 | C1 |
| Example 6 | Bk-1 | X1 | C1 | Y-2 | X7 | C1 | M-2 | X7 | C1 | C-2 | X7 | C1 |
| Example 7 | Bk-1 | X1 | C1 | Y-3 | X8 | C1 | M-3 | X8 | C1 | C-3 | X8 | C1 |
| Example 8 | Bk-6 | X9 | C1 | Y-1 | X2 | C1 | M-1 | X2 | C1 | C-1 | X2 | C1 |
| Example 9 | Bk-7 | X10 | C1 | Y-1 | X2 | C1 | M-1 | X2 | C1 | C-1 | X2 | C1 |
| Example 10 | Bk-8 | X1 | C2 | Y-4 | X2 | C2 | M-4 | X2 | C2 | C-4 | X2 | C2 |
| Example 11 | Bk-9 | X1 | C3 | Y-5 | X2 | C3 | M-5 | X2 | C3 | C-5 | X2 | C3 |
| Comparative 1 | Bk-10 | X11 | C1 | Y-1 | X2 | C1 | M-1 | X2 | C1 | C-1 | X2 | C1 |
| Comparative 2 | Bk-11 | X12 | C1 | Y-1 | X2 | C1 | M-1 | X2 | C1 | C-1 | X2 | C1 |

[Evaluation]

(1) Measurement of Exothermic Peak Temperature

The toner particle of the toner of each color was subjected to measurement using a thermal analyzer “Diamond DSC” (manufactured by PerkinElmer, Inc.) under the above-described conditions to measure the exothermic peak temperature of the toner of each color in the temperature decrease.

(2) Low-Temperature Fixability

The toners of each toner set listed in Table 2 were loaded in a modified machine of a copying machine “bizhub PRO C6501” (manufactured by Konica Minolta, Inc., “bizhub” being their registered trademark). In this modified machine, a fixing device had been modified so that the surface temperature of a fixing heat roller could be changed in a range of 100 to 210° C. Then, a fixing experiment in which a solid image with a toner adhering amount of 11 mg/10 cm² of the toner of each color was fixed on A4-size normal paper (having a weight of 80 g/m²) was repeatedly performed at prescribed fixing temperatures. The fixing temperature was set to temperatures from 85° C. to 130° C. at 5° C. intervals.

Next, each printed matter obtained in the fixing experiment performed at each fixing temperature was folded using a folding machine with the solid image valley folded (with the solid image inside), and compressed air of 0.35 MPa was blown against a fold created on the solid image. The resultant fold was evaluated into any of five ranks of the following criteria 1, and a fixing temperature employed in the fixing experiment performed at the lowest fixing temperature among those evaluated as rank 3 was defined as a lowest limit fixing temperature for evaluation.

(Criteria 1)

Rank 5: No peeling is caused.

Rank 4: Partial peeling is caused along the fold.

Rank 3: Small linear peeling is caused along the fold.

Rank 2: Large linear peeling is caused along the fold.

Rank 1: Large peeling is caused.

On the basis of the thus obtained lowest limit fixing temperature, the low-temperature fixability of each toner set was evaluated based on the following criteria 2. As the lowest limit fixing temperature of a toner set is lower, it means that the toner set is better in the low-temperature fixability, and if the lowest limit fixing temperature is 120° C. or lower (i.e., “A”, “B” or “C”), there arises no practical problem, and hence the toner set is determined acceptable.

(Criteria 2)

A: The lowest limit fixing temperature is 105° C. or lower.

B: The lowest limit fixing temperature is higher than 105° C. but 118° C. or lower.

C: The lowest limit fixing temperature is higher than 118° C. but 120° C. or lower.

D: The lowest limit fixing temperature is higher than 120° C.

(3) Transferability

The aforementioned copying machine was used for performing a durability test in which an image was formed using the toners of each toner set on 10,000 sheets of the above-described A4-size normal paper. The image had a coverage rate of each color of 5%. Specifically, before and after the durability test, a solid image (20 mm×100 mm) having a toner adhering amount of the toner of each color of 5.0 g/m² was formed as a measurement image. In forming the measurement image, a ratio (%) of the mass W1 (g) of the toner of each color transferred onto the intermediate transfer belt to the mass W0 (g) of the toner of that color supplied onto the photoconductor (used for the development) was obtained as a transfer ratio tr(K), tr(Y), tr(M) or tr(C). The mass W0 was measured by collecting, with an adhesive tape, the toner corresponding to an area of 2×5 mm (10 mm²) in the toner image developed on the photoconductor, and the mass W1 was measured by collecting, with an adhesive tape or the like, the toner corresponding to an area of 2×5 mm (10 mm²) in the toner image adhering to but not fixed on the sheet.

Besides, in the transfer ratios of the toners of the respective colors, a difference Δtr between the largest value and the smallest value was obtained, and the transferability of each toner set was evaluated on the basis of the difference Δtr based on the following criteria 3. If the difference Δtr is smaller than 10% (i.e., “A”, “B” or “C”), the toner set is determined as acceptable.

(Criteria 3)

A: The difference Δtr is smaller than 2%.

B: The difference Δtr is 2% or larger but smaller than 7%.

C: The difference Δtr is 7% or larger but smaller than 10%.

D: The difference Δtr is 10% or larger.

The exothermic peak temperatures and the results of the above-described evaluations of the toners of the respective colors are shown in Table 3. In Table 3, “rc(Y)” indicates the exothermic peak temperature of the yellow toner, “rc(M)” indicates the exothermic peak temperature of the magenta toner, “rc(C)” indicates the exothermic peak temperature of the cyan toner, and “rc(K)” indicates the exothermic peak temperature of the black toner. Besides, in Table 3, “ΔrcYK” means the “difference between the exothermic peak temperatures rc(Y) and rc(K)”, “ΔrcMK” means the “difference between the exothermic peak temperatures rc(M) and rc(K)”, and “ΔrcCK” means the “difference between the exothermic peak temperatures rc(C) and rc(K)”.

TABLE 3

| | Exothermic | | | | | | | | | | | | | |
|---|---|---|---|---|---|---|---|---|---|---|---|---|---|---|
| | Peak Temperature | | | | | | | | Transferability | | | | | |
| | rc(Y) | rc(M) | rc(C) | rc(K) | ΔrcYK | ΔrcMK | ΔrcCK | Low-temperature | tr(Y) | tr(M) | tr(C) | tr(K) | Δtr | |
| | [° C.] | [° C.] | [° C.] | [° C.] | [° C.] | [° C.] | [° C.] | Fixability | [%] | [%] | [%] | [%] | [%] | Evaluation |
| Example 1 | 65.0 | 65.4 | 66.7 | 62.2 | 2.8 | 3.2 | 4.5 | A | 98 | 97 | 97 | 96 | 2 | A |
| Example 2 | 65.0 | 65.4 | 66.7 | 64.2 | 0.8 | 1.2 | 2.5 | A | 98 | 97 | 97 | 91 | 7 | C |
| Example 3 | 65.0 | 65.4 | 66.7 | 57.3 | 7.7 | 8.1 | 9.4 | B | 98 | 97 | 97 | 95 | 3 | B |
| Example 4 | 65.0 | 65.4 | 66.7 | 63.4 | 1.6 | 2.0 | 3.3 | A | 98 | 97 | 97 | 93 | 5 | B |
| Example 5 | 65.0 | 65.4 | 66.7 | 59.0 | 6.0 | 6.4 | 7.7 | B | 98 | 97 | 97 | 94 | 4 | B |
| Example 6 | 67.0 | 67.1 | 68.0 | 62.2 | 4.8 | 4.9 | 5.8 | A | 94 | 93 | 94 | 96 | 3 | B |
| Example 7 | 64.0 | 64.2 | 65.0 | 62.2 | 1.8 | 2.0 | 2.8 | B | 98 | 98 | 98 | 96 | 2 | A |
| Example 8 | 65.0 | 65.4 | 66.7 | 60.0 | 5.0 | 5.4 | 6.7 | B | 98 | 97 | 97 | 96 | 2 | A |
| Example 9 | 65.0 | 65.4 | 66.7 | 63.9 | 1.1 | 1.5 | 2.8 | B | 98 | 97 | 97 | 91 | 7 | B |
| Example 10 | 47.8 | 49.7 | 49.9 | 46.0 | 1.8 | 3.7 | 3.9 | A | 93 | 91 | 93 | 90 | 3 | B |
| Example 11 | 73.1 | 73.2 | 74.0 | 72.0 | 1.1 | 1.2 | 2.0 | B | 97 | 98 | 98 | 92 | 6 | B |
| Comparative | 65.0 | 65.4 | 66.7 | 66.7 | −1.7 | −1.3 | 0 | C | 98 | 97 | 97 | 84 | 14 | D |
| Example 1 | | | | | | | | | | | | | | |
| Comparative | 65.0 | 65.4 | 66.7 | 54.3 | 10.7 | 11.1 | 12.4 | D | 98 | 97 | 97 | 91 | 7 | C |
| Example 2 | | | | | | | | | | | | | | |

All the toner sets of Examples 1 to 11 have sufficient low-temperature fixability and transferability. Besides, it is understood, from Table 3, that the difference in the exothermic peak temperature between the chromatic color toners and the black toner is in a range of 1 to 10° C. in all the toner sets. It is also understood, from Table 3, that the exothermic peak temperatures of the toners are in a range of 45 to 75° C. in all the toner sets.

In contrast, the toner set of Comparative Example 1 is insufficient in the transferability. This is probably because the exothermic peak temperature of the black toner is too high as compared with the exothermic peak temperatures of the chromatic color toners, and hence the charge stability is insufficient in transferring the toner image, resulting in causing an image defect in transferring.

The toner set of Comparative Example 2 is insufficient in the low-temperature fixability. This is probably because the molecular weight of the black toner is too high as compared with those of the chromatic color toners, and hence the melt property of the toners is degraded.

According to the present invention, in forming an electrophotographic full color image, good low-temperature fixability and good transferability can be both attained. Accordingly, the electrophotographic image forming technique is expected to be further developed by the present invention.

What is claimed is:

1. An electrophotographic image forming method, comprising transferring, from a photoconductor onto a transfer member, at least one toner selected from the group consisting of a yellow toner, a magenta toner, a cyan toner and a black toner, the at least one toner being born on the photoconductor and developing an electrostatic latent image on the photoconductor,
wherein each of the yellow toner, the magenta toner, the cyan toner and the black toner contains an amorphous resin, a crystalline resin and a colorant,
the colorant of the black toner contains a conductive black colorant, and
exothermic peak temperatures of the yellow toner, the magenta toner, the cyan toner and the black toner obtained in temperature decrease in differential scanning calorimetry satisfy the following expressions 1-1 to 1-3:
0.5≦rc(Y)−rc(K)≦10 Expression 1-1:
0.5≦rc(M)−rc(K)≦10 Expression 1-2:
0.5≦rc(C)−rc(K)≦10 Expression 1-3:
wherein rc(K) represents the exothermic peak temperature (° C.) of the black toner, rc(Y) represents the exothermic peak temperature (° C.) of the yellow toner, rc(M) represents the exothermic peak temperature (° C.) of the magenta toner, and rc(C) represents the exothermic peak temperature (° C.) of the cyan toner.

2. The image forming method according to claim 1, wherein the exothermic peak temperatures of the yellow toner, the magenta toner, the cyan toner and the black toner satisfy the following expressions 2-1 to 2-3:
1.5≦rc(Y)−rc(K)≦8 Expression 2-1:
1.5≦rc(M)−rc(K)≦8 Expression 2-2:
1.5≦rc(C)−rc(K)≦8 Expression 2-3:

3. The image forming method according to claim 1, wherein the exothermic peak temperatures of the yellow toner, the magenta toner, the cyan toner and the black toner satisfy the following expressions 3-1 to 3-3:
3≦rc(Y)−rc(K)≦6 Expression 3-1:
3≦rc(M)−rc(K)≦6 Expression 3-2:
3≦rc(C)−rc(K)≦6 Expression 3-3:

4. The image forming method according to claim 1, wherein the yellow toner, the magenta toner, the cyan toner and the black toner all contain the same crystalline resin.

5. The image forming method according to claim 1, wherein the crystalline resin is crystalline polyester.

6. The image forming method according to claim 1, wherein contents of the crystalline resin in each of the yellow toner, the magenta toner, the cyan toner and the black toner are 5 to 20 mass %.

7. The image forming method according to claim 1, wherein the exothermic peak temperatures of the yellow toner, the magenta toner, the cyan toner and the black toner are 45 to 75° C.

8. A toner set comprising a yellow toner, a magenta toner, a cyan toner and a black toner, to be used in an electrophotographic image forming method including transferring, from a photoconductor onto a transfer member, at least one toner selected from the group consisting of the yellow toner, the magenta toner, the cyan toner and the black toner, the at least one toner being born on the photoconductor and developing an electrostatic latent image on the photoconductor,
wherein each of the yellow toner, the magenta toner, the cyan toner and the black toner contains an amorphous resin, a crystalline resin and a colorant,
the colorant of the black toner contains a conductive black colorant, and
exothermic peak temperatures of the yellow toner, the magenta toner, the cyan toner and the black toner obtained in temperature decrease in differential scanning calorimetry satisfy the following expressions 1-1 to 1-3:
0.5≦rc(Y)−rc(K)≦10 Expression 1-1:
0.5≦rc(M)−rc(K)≦10 Expression 1-2:
0.5≦rc(C)−rc(K)≦10 Expression 1-3:
wherein rc(K) represents the exothermic peak temperature (° C.) of the black toner, rc(Y) represents the exothermic peak temperature (° C.) of the yellow toner, rc(M) represents the exothermic peak temperature (° C.) of the magenta toner, and rc(C) represents the exothermic peak temperature (° C.) of the cyan toner.
